(19) United States
(12) Patent Application Publication
(10) Pub. No.: US 2023/0128256 A1
(43) Pub. Date: Apr. 27, 2023

(54) FINANCIAL HEALTH SIMULATION SYSTEM

(71) Applicant: VeraScore Inc., San Anselmo, CA (US)

(72) Inventors: Trond Henning Olesen, Pleasanton, CA (US); Geoffrey Woodward, San Anselmo, CA (US); Mark Robert Wicker, Petaluma, CA (US)

(21) Appl. No.: 17/971,554

(22) Filed: Oct. 22, 2022

Related U.S. Application Data
(60) Provisional application No. 63/270,871, filed on Oct. 22, 2021.
(60) Provisional application No. 63/270,861, filed on Oct. 22, 2021.
(60) Provisional application No. 63/270,879, filed on Oct. 22, 2021.
(60) Provisional application No. 63/270,890, filed on Oct. 22, 2021.

(51) Int. Cl. G06Q 40/02

(52) U.S. Cl. CPC G06Q 40/025

(57) ABSTRACT

Systems and methods are described for providing a financial health score simulator for a consumer or entity. In some aspects, a request to simulate an impact on a financial health score of an entity caused by a change in at least one of a subset of financial data values used to determine the financial health score may be obtained. A past financial health score may be obtained including values for at least three of a debt-to income factor, a total spending factor, a debt/debt portfolio factor, a saving factor, a liquid reserves factor, or a payment history factor. A simulated financial health score may be calculated using the at least one changed value for at least one of the subset of financial data values. An indication the simulated financial health score may then be provided to the requesting device.

### CROSS-REFERENCE TO RELATED APPLICATIONS

This application claims benefit of U.S. Provisional Patent Application No. 63/270,861, filed Oct. 22, 2021, entitled “DETERMINING A CONSUMER'S FINANCIAL HEALTH SCORE”; U.S. Provisional Patent Application No. 63/270,871, filed Oct. 22, 2021, entitled “FINANCIAL HEALTH SCORE SIMULATION/WHAT-IF ANALYSIS”; U.S. Provisional Patent Application No. 63/270,879, filed Oct. 22, 2021, entitled “DETERMINING A CONSUMER'S BENEFICIAL, NEUTRAL, AND ADVERSE DEBT”; and U.S. Provisional Patent Application No. 63/270,890, filed Oct. 22, 2021, entitled “CATEGORIZING CONSUMER'S FINANCIAL DATA FOR A FINANCIAL HEALTH SCORE”, the entireties of which are herein incorporated by reference in their entireties.

### BACKGROUND

Presently, there is no method or process that can accurately and objectively measure the financial health of a consumer. Unfortunately, many people confuse a credit score with how financially healthy a consumer is, but a credit score does not represent the financial health of a consumer. There are many drawbacks and deficiencies with the current alternatives to a consumer's financial health—i.e., credit scores, including one or more of the following. Existing processes do not use enough data to determine an accurate score. Existing processes, like e.g., a credit score, only use a very “narrow” set of data sources like e.g., credit data—that have also been proven to have major problems with inaccuracies. There is no use of personal financial data like income, expenses, Liquid Reserves, etc. Without such data, there is no way to know or understand a consumer's financial health. Existing processes have low data accuracy. As stated above, data from credit bureaus are fraught with inaccuracies. One investigation concluded that approximately 25% of all credit bureau data had inaccuracies that would result in a faulty credit score, resulting in denial of access to credit. Credit scores are easy manipulated. A credit score can easily be manipulated by e.g., opening more credit card accounts, thereby having more available credit and hence increasing the credit score. From a financial health standpoint, increasing the access to credit through credit cards can be very detrimental as such credit most often carries very high interest rates. Existing processes do not accurately determine loan default risk. Past performance is often a good indication of future performance—which is one of the aspects credit scores are basing their scores on—but without also knowing the consumer's income and expenses/spending, it is not possible to know the true risk of a consumer defaulting on their loan.

In addition, existing techniques are fraught with inequity. If a consumer does not have credit cards or is not using their credit on a regular basis, they will either not have a credit score at all or have a very low credit score (in other words, they will be either “credit invisible” or “credit unscorable”). A consumer can be financially very healthy—e.g., paying all their bills on time, putting money aside to weather a financial issue—and not have any credit cards or loans. By not allowing such consumers “access” to a credit score, they have a very hard time getting access to mainstream banking credit products. Along these same lines, these techniques result in poor access to credit for underserved communities. By being less equitable (see above), credit scores can in essence “prohibit” consumers (without a credit score or with low credit score) access to mainstream lenders. Unfortunately, underserved communities are “over represented” when it comes to credit un-scorable or credit invisible consumers. Being “denied” access to prime loans also makes it far more difficult for such consumers to build wealth.

In some cases, these systems and techniques may suffer from a general lack of data transparency. The consumer cannot see all the base data the credit scoring companies use for determining a consumer's credit score. By not allowing access, the consumer cannot determine the accuracy of the data being used and hence whether or not their credit score is accurate. Similarly the way the score is calculated may lack transparency. Credit scores provide very little insight into the scoring process and, in fact, credit scoring companies state that a consumer cannot determine their credit score on their own. Without score transparency, there is nobody outside of the credit scoring agencies that can verify whether or not a credit score is accurate or if the correct algorithm was used to create the credit score. These scores may be based off of insufficient financial history. Credit scores are only calculated on an as-needed basis using only the then-current credit data and hence only provides a “snapshot” of a consumer's credit at that point-in-time. This means there is no historical picture of the credit score for a consumer which means neither the lender nor the consumer will have a picture of the consumer's past performance.

### BRIEF DESCRIPTION OF THE DRAWINGS

Various techniques will be described with reference to the drawings, in which:

FIG. 1 illustrates an example evaluation system, according to at least one embodiment;

FIG. 2 illustrates an example process for generating a financial evaluation, which may be performed by the evaluation system of FIG. 1, according to at least one embodiment;

FIGS. 3-9 illustrates example processes for generating factors that may be used by the financial evaluation process of FIG. 2, which may be performed by the evaluation system of FIG. 1, according to at least one embodiment;

FIG. 10 illustrates another example process for generating a financial evaluation, which may be performed by the evaluation system of FIG. 1, according to at least one embodiment

FIG. 11A illustrate an example process for categorizing input data, which may be performed or used by the evaluation system of FIG. 1, according to at least one embodiment;

FIG. 11B illustrate an example categorizing scheme for financial data, such as may be used by process 1100a of FIG. 11A, according to at least one embodiment; and

FIGS. 12-13 illustrates example processes for simulating a financial evaluation, which may be performed by the evaluation system of FIG. 1, according to at least one embodiment.

### DETAILED DESCRIPTION

Systems and methods are described herein for generating an accurate and balanced evaluation of a consumer or entity's financial health. For many years, lenders have struggled to accurately and objectively assess a consumer's ability to take on (more) debt and their ability to repay a potential loan. Credit scores do not and cannot accurately assess a consumer's total finances as they only consider a consumer's credit data, and hence lenders have no choice but to request more financial data from the consumer (and the consumer's financial institutions) in order to get a “broader” picture of the consumer's finances. Although this provides the lenders more information, it does not provide a complete picture of the consumer's financial habits or patterns over time, nor does it provide a history of a consumer's finances. Presently there are many different companies that provide consumers with advice as to how they can become more financially healthy (either on a paid-for or for-free basis). As lenders use different methods and data to assess consumers, these companies cannot “guarantee” that their financial advice will make the consumer become more attractive to the lenders.

Current credit scoring systems and techniques do not take into account a long enough history of a consumer's spending habits, and hence cannot accurately predict 1) whether the consumer will be able to reasonably take on more debt, and 2) cannot accurately advise consumers how to improve their financial habits. In addition, current systems do not examine a consumer's spending history on a granular level such that the information cannot be used to accurately predict future spending habits and the like. Furthermore, current systems do not provide transparency to a consumer to enable them to improve their credit health and obtain more debt, etc. In part by identifying these issues, and other issues with current systems as will be described throughout this disclosure, new techniques and systems have been developed to provide a more thorough financial analysis with key insights that provide better indications of a consumer's financial health and the health of their financial habits.

In some examples, the described systems and techniques addresses one or more of these deficiencies by generating a balanced score or evaluation of a consumer or entity's financial health. The described score or evaluation, referred to throughout this disclosure as a financial health score or FHS. Such a financial health score in various embodiments can provide any lender with an objective benchmark for any consumer across some or all geographies and some or all communities. In various examples, such a financial health score can provide lenders with a complete, and historical, picture of a consumer's financial health, and can enable lenders to assess how a potential new loan will affect the consumer's financial health. This can reduce the risk of a consumer defaulting on a current or potential new loan in various embodiments, and in some aspects, can enable the institution to offer loans to otherwise underserved consumers.

With a transparent financial health score of some examples, the consumer may access information to enable them to improve their financial health and thereby become more attractive to lenders. As the financial health score of various embodiments can take into consideration some or all of the consumer's relevant financial data, and not just credit data (which can be fraught with inaccuracies) as credit scores do, it can increase access to credit for all consumers (e.g., even consumers with no credit score or with a poor credit score), thereby increasing equity. In some embodiments, a financial health score can allow consumers to understand their financial health not just before taking on a new loan but also how the new loan will affect their financial health going forward.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

As one skilled in the art will appreciate in light of this disclosure, certain embodiments may be capable of achieving certain advantages, including some or all of the following: (1) a more accurate way to analyze a consumer or entity's financial health; (2) more efficient utilization of computing resources to determine financial health scores; and (3) other advantages as will be made apparent in the rest of this disclosure.

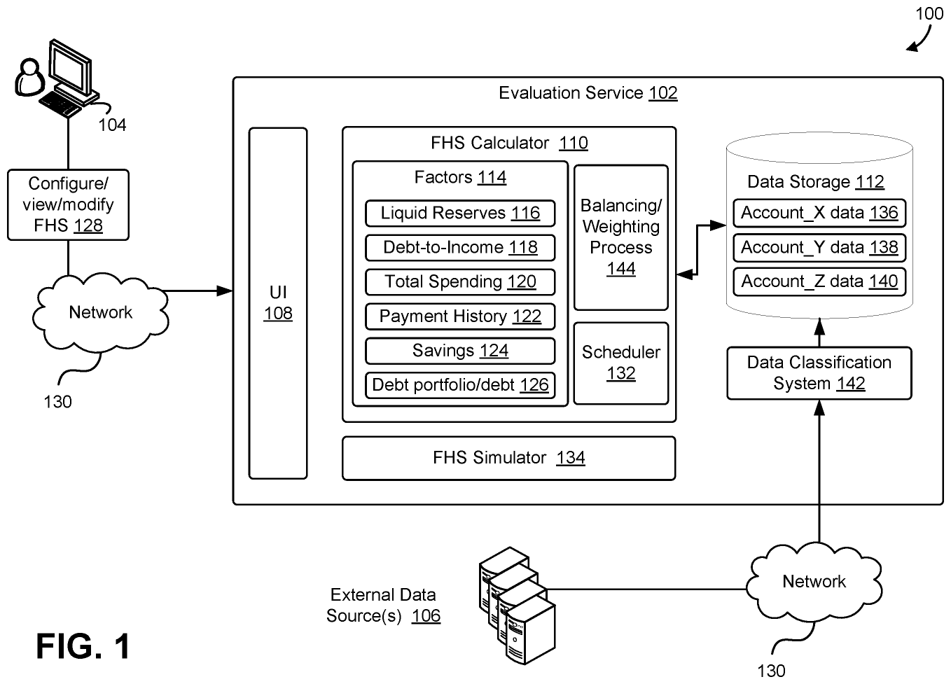

FIG. 1 illustrates an example environment 100, which includes a financial evaluation service or system 102 that may interact with various client devices 104 and/or external data sources 106 over one or more networks 130. In some cases, the evaluation service or system 102 may be provided by one or more computing devices, (e.g., servers, cloud computing resources, etc.) such as connected over a network. In other cases, the evaluation service 102 may be provided by a cloud or computing resource service provider.

User device 104 may refer to a client computer system or computing device (such as a laptop, smartphone tablet, desktop computer, etc.) connected to the evaluation service 102 over a network 130. In some cases, device 104 refers to a user or operator of a client computer system, and may be a consumer or entity using a computing device that is looking to access their financial health score. In other cases, user device 104 may include a loan originator or lending institution, looking to verify a consumer or entity to provide them a loan, mortgage, etc. User device 104 may be an employee of an organization that utilizes the evaluation service 102 to interact with various forms of data, such as account data 136-140, managed and/or stored by one or more of a data storage 112. User device 104 may submit a request 128 to configure, view, or modify a financial health score determined by the evaluation service 102 over network 130. The request 128, in some examples, is a web service application programming interface request (also referred to simply as a web service request).

In some cases, the network 130 includes any appropriate network, including an intranet, the Internet, a cellular network, a local area network, a satellite network or any other such network and/or combination thereof, and components used for such a system depend at least in part upon the type of network and/or system selected. Many protocols and components for communicating via such a network are well known and will not be discussed herein in detail. In an embodiment, communication over the network 130 is enabled by wired and/or wireless connections and combinations thereof. In some cases, a network may include or refer specifically to a telephone network such as a public switched telephone network or plain old telephone service (POTS).

The evaluation service 102 may provide services that may be accessible through various software, hardware, and/or variations thereof. In some examples, the services may be implemented as software applications or services executing on various computing devices. Examples of such computing devices include one or more instances of a physical computing instance (e.g., a physical server computer, a mobile communication device, a laptop computer, a tablet computer, a personal computer, a mainframe, etc.) or one or more instances of a virtual computing instance, such as a virtual machine hosted on one or more computer servers, or other various capable computing systems.

From a high level, the evaluation service 102 may collect various data pertaining to an individual (consumer) or entity, and may generate an evaluation of that individual or entity with respect to one or a number of different financial metrics or factors. The evaluation service 102 may include a user interface (UI) component 108, that may interface with various user, client, or consumer devices 104 via messages 128 over a network 130. The UI component 108 may provide an application including various selectable items for configuring, modifying, and viewing a financial health score, among other things, to the customer device 104, as represented via message 128. The UI 108 may provide various selection item or selectable items that enable the user device 104 to submit various financial data (either the data itself or access information such that the evaluation service 102 can obtain the information from financial institutions, etc.) and/or confirm that all the data submitted is accurate and includes a complete financial picture for determination of the FHS. In some cases, the UI 108 may provide a summary of the financial data obtained and request for verification of the data, to ensure accuracy of the data.

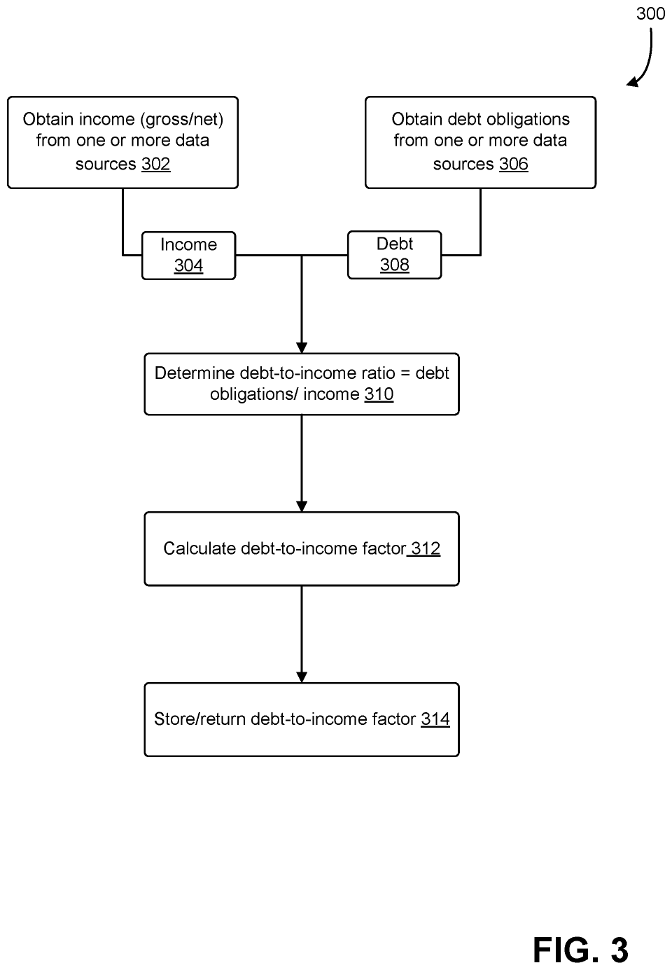

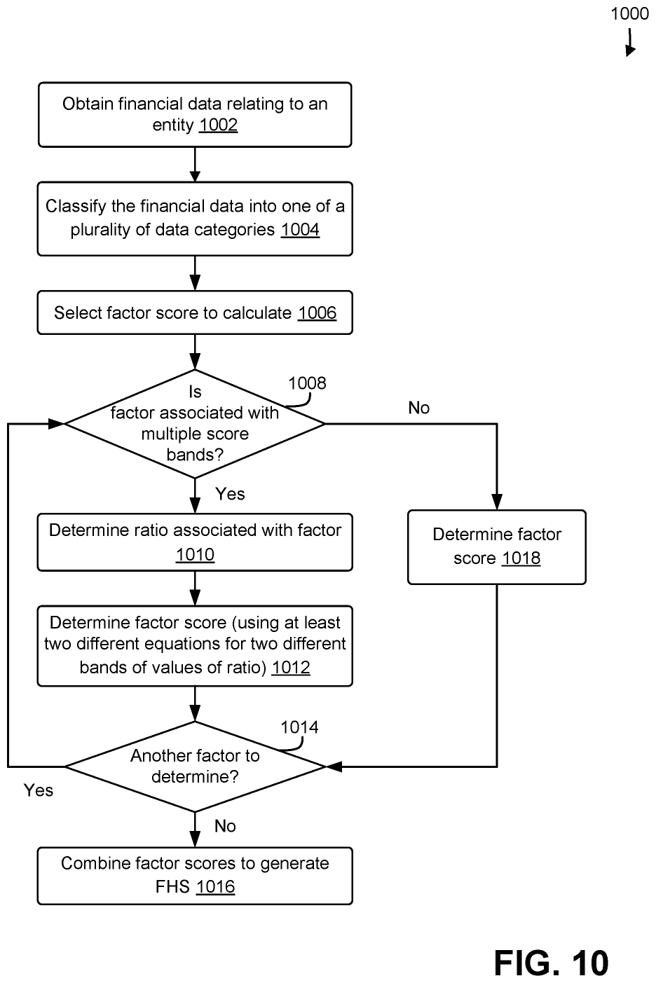

The evaluation service 102 may also include an FHS calculator 110, which may be a collection of computing resources that determines, via the techniques described in more detail below, a financial health score (FHS) or evaluation of a consumer or entity. The FHS calculator 110 may include or access processes that determine one of a number of different factors 114 of a financial heath score, such as a liquid reserves factor 116, a debt-to-income factor 118, a total spending factor 120, a payment history factor 122, a savings factor 124, and a debt portfolio/debt factor 126. Example ways to determine each of these factors will be described in greater detail below in reference to FIGS. 3-9. The FHS calculator 110 may determine one or more of these factors and then apply or modify the score for a given factor by a balancing/weighting process 144. Balancing/weighting process 144 may scale the importance of one or more factors 114 based on a number of different considerations, such as a value of one or more pieces of financial data relating to the consumer or entity, a value of one or more other factors 114, and so on. A more detailed of example of a weighting or balancing process will be described in greater detail below in reference to FIG. 10. In some aspects, the balancing/weighting process 144 may associate a weight to each score of the six scores based on a relative importance of the associated factor, wherein the importance is ranked from highest to lowest for example in the following order: the liquid reserves factor, the debt-to-income factor, the total spending factor, the payment history factor, the savings factor, and the debt portfolio/debt factor. It should be appreciated that other rankings, orders, and weighting schemes are contemplated herein.

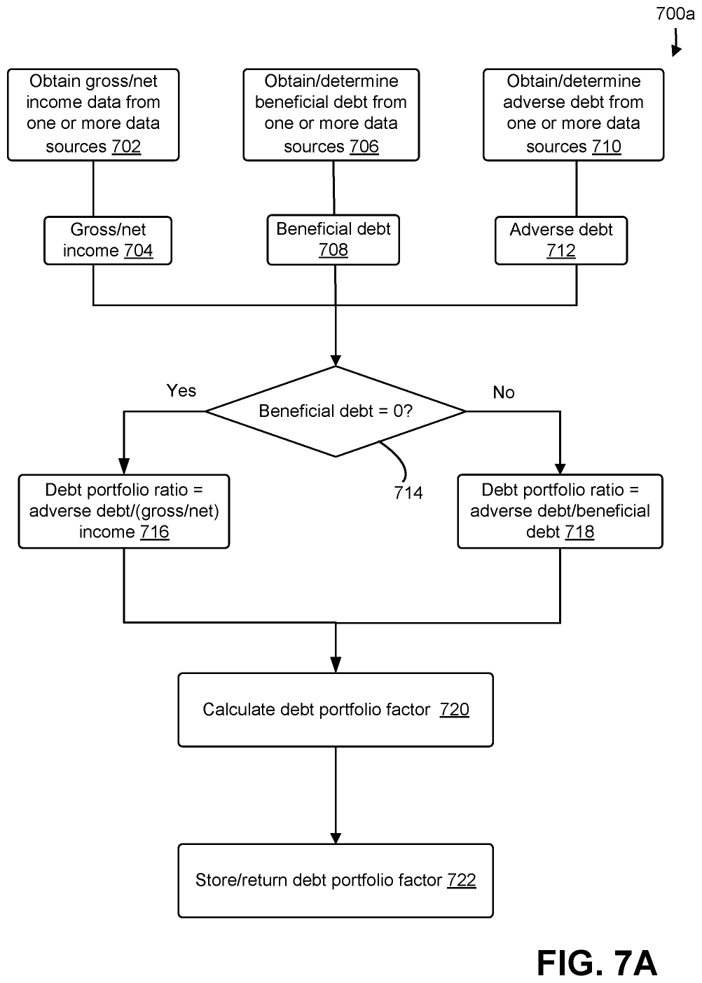

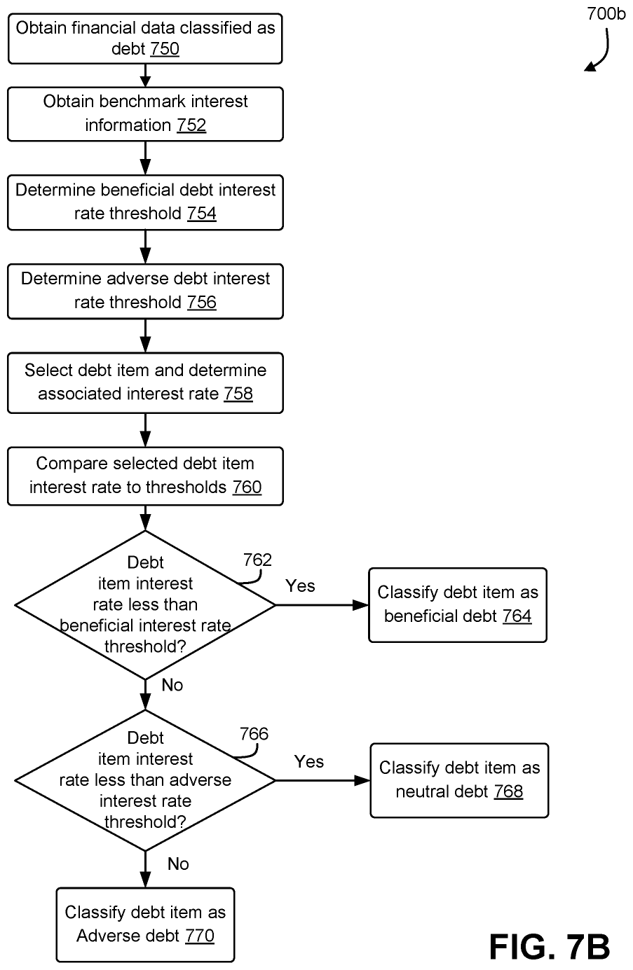

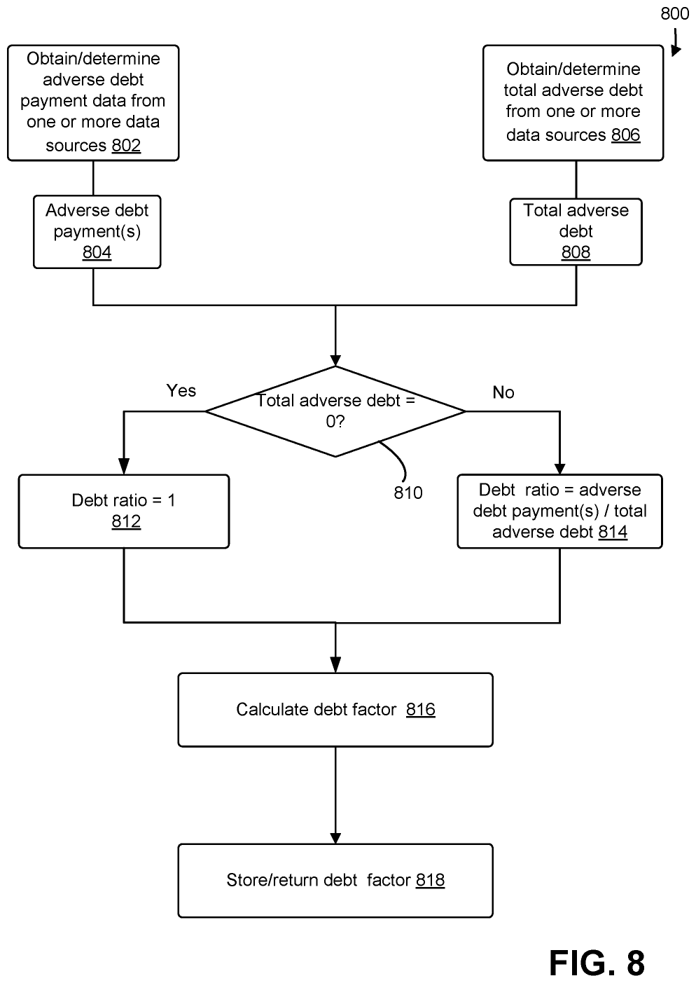

In some cases, one, two, three, four, five, six, or even seven scores (one for debt factor and another for debt portfolio factor, as will be described below in reference to FIGS. 7 and 8) may be combined by the balancing/weighting process 144 to yield an overall financial health score. In some cases, a factor score may range from zero percent to 100 percent for one or more of Debt-to-income factor, liquid reserves factor, savings factor, total spending factor, debt portfolio/debt factor, and payment history factor. Various embodiments can combine such factors (and others) into the overall financial health score—which in some examples can be a score from zero percent to 100 percent.

When combining the factors, in various embodiments it can be desirable to do it in a way that produces a balanced overall formula. For example, each of the factors can focus on an important aspect of a consumer's health (as described earlier), but some of the same data categories can appear in several factors: Debt-to-income factor: gross/net income, debt obligations, Liquid Reserves factor: Total Spending, Liquid Reserves, Savings factor: gross/net income, Savings amount, Total Spending factor: net income, Savings amount, Total Spending, Debt Portfolio factor: beneficial debt, adverse debt, gross/net income, Debt factor: adverse debt payment, total adverse debt, Payment History factor: late payments, age of late payments.

A balanced overall formula may be desirable to safeguard against the consumer manipulating the formula by e.g., moving money/spending between different data categories to try to achieve an artificially higher financial health score. To examine this a little closer, in various examples there is (normally) very little a consumer can do to “manipulate” their (gross or net) income, debt obligations (and hence beneficial/neutral/adverse debt), late payments and the age of the late payments. In some embodiments, a consumer can manipulate the financial health score by saving more (e.g., per month) or spending less, but by doing so consistently, the consumer can indeed be becoming more financially healthy so the financial health score can then correctly measure the consumer's financial health. Therefore, in various embodiments the factors (and hence data categories in various example) above can be balanced such that they are not easily susceptible to manipulation.

Some embodiments can consider the importance of each of the factors. Various embodiments encompass and allow for using any suitable weighting/importance for the factors when calculating the overall Financial Health Score. When using weighting, in some examples it can be desirable to find the right order of the factors involved to make sure the overall financial health score correctly reflects the consumer's financial health or reflects the consumer's financial health in a desired way. As an example, the importance of the factors can be as follows: liquid reserves factor (most important), debt-to-income factor, total spending factor, payment history factor, savings factor, debt portfolio factor (least important).

In some cases, the FHS calculator 110 may also include a scheduler or scheduling component 132, which may set and/or initiate the FHS calculator 110 to obtain new data and recalculate the FHS score or evaluation on any given schedule. In some cases, scheduler 132 may operate on a configurable timeline, such as prompting the FHS calculator 110 to determine an FHS score for a consumer or entity on a regular basis, such as weekly, bi-weekly, monthly, every 2, 3, 4, 5, 6, 12 months, and so on. In yet other cases, the scheduler 132 may initiate a new FHS score workflow based on detecting or receiving new financial data for a given account. In yet some cases, the scheduler 132 may initiate the FHS calculator 110 to determine a new FHS score for a rolling time period, such as e.g., six months, where the scheduler triggers the FHS calculator to calculate a new FHS score every month that includes the prior 6 months of data. In some cases, the financial data used to determine that FHS score may be stored as account information or data 136, 138, 140 in data storage 112. In these cases, the data may be stored using known encryption techniques and/or other security measure to protect the sensitive financial data from outside exposure. In other cases, the evaluation service 102 and/or FHS calculator 110 may obtain the financial data directly from external data sources 106 every time (or most times) it determines an FHS score, to minimize the security risk with storing sensitive financial data for various consumers and entities.

Various embodiments can consider a schedule to use for the financial health s core. By its very nature, some of the data categories can vary quite a lot in some examples throughout the year. For example, property taxes are normally paid once or twice a year, insurance can be paid on any schedule (monthly, bi-monthly, quarterly, half-yearly, yearly), bonuses can also be paid on any schedule, purchase of a car can be on an as needed basis (and normally not even every year), major repairs happen sporadically (hopefully not every year), etc. This can mean that if only the daily/weekly/monthly financial health score is considered to gauge a consumer's financial health, in some embodiments it could vary quite a bit (from day/week/month to day/week/month). Various embodiments can encompass and allow for calculating the financial health score on any suitable schedule, e.g., monthly, bi-monthly, quarterly, half-yearly, yearly, or any other schedule that makes financial sense.

When calculating the financial health score on a schedule other than e.g., every month, various embodiments encompass and allow for performing the calculations any suitable way. For example, the financial health score can be calculated monthly and then the average of the monthly health score may be used to calculate the 3 months/6 months/12 months/etc. financial health score. The total of each data category for 3 months/6 months/12 months/etc. may also be used and the same example formulas, as described in more detail below, may be used to calculate the 3 months/6 months/12 months/etc. financial health score. Various embodiments encompass and allow for using any suitable mathematical formula to calculate the financial health score over the chosen time period (e.g., 3 months, 6 months, 12 months, etc.)

In some embodiments, if it is chosen to use a window longer than 1 month to calculate the financial health score, it may be desirable to use a floating window to keep track of the historical financial health score for a consumer. For example, if it is selected to calculate the financial health score on a 6 months basis, in some examples, the financial health score may be calculated for the last 6 months, every month. In other words, in March, the financial health score would be determined for September, October, November, December, January, and February, and then in April, the financial health score for October, November, December, January, February, and March would be determined, and so on for every month. Various embodiments encompass and allow for using any suitable floating window to calculate the financial health score.

In some cases, FHS calculator 110 or any component thereof, may access various data pertaining to a consumer/entity, from a data store or data storage system 112. The data storage system 112 may ensure that account data 136, 138, 140 is stored securely, via various techniques known in the art. The data storage system 112 may be a collection of computing resources or processes configured to organize, storage, manage, and run queries on various data sets organized by account, 136, 138, 140. The data storage system 112 may include various hardware, software, and/or virtualized computing resources to store and manage data obtained for various consumers. In some cases, data storage system 112 may be a physical asset, such as physical computing devices or servers utilized by the evaluation service 102. In other cases, the data storage system 112 may be a managed service, such as provided by another entity, that makes it easy for users to set up, operate, and scale databases that house data sets 136, 138, 140 in various forms. In some cases, the data storage system 112 may rely on the virtualization techniques (e.g., via cloud computing resources and/or virtualized machines and/or software containers) to allocate the compute and storage resources to provide a data storage. The data storage system 112 may provide one or more of a variety of database or query engines (e.g., relational database engines such as MySQL, MariaDB, Oracle, SQL Server, PostgreSQL, etc., graph model and/or query language, and/or non-relational database engines) allowing existing code, applications, and/or tools to enable efficient access to various data sets 136, 138, 140. In some embodiments, the data storage system 112 may perform administrative tasks such as automatically backing up databases, upgrading and/or patching database software, scaling the compute resources or storage capacity associated with its database instances, etc.

In yet some aspects, the data storage system 112 may be an on-demand data storage service, such as an object-based data storage service, and may be configured to store various forms of data. The data storage system 112 may comprise one or more processors and memory that stores executable instructions whose execution by the one or more processors causes the computer system to perform operations described herein. In some examples, data stored in the data storage service 112 which may collectively form data sets 136, 138, 140, may be organized into data objects. The data storage system 112 may store numerous data objects of varying sizes. The data storage system 112 may operate as a key value store that associates data objects with identifiers of the data objects which may be used by the client 104 to retrieve or perform other operations in connection with the data sets 136, 138, 140 stored by the data storage system 112. Access to the object-based data storage system 112 may be through application programming interface (API) calls to the service or via an interface, such as a graphical user interface (GUI).

In some cases, a data classification system 142 may obtain and classify various data pertaining to a consumer or entity from one or more external data sources 106 via one or more networks 130. In some cases, the data classification system 142 may obtain the data actively, such as searching through account information from various external data sources 106, which may include banking sources, loan providers, credit card companies, utility providers, etc. In other cases, other components or aspects of the evaluation service 102 may actively obtain the data, or setup interfaces that automatically push/pull data from one or more of these various sources upon new information becoming available, and/or new information satisfying one or more configurable criteria becomes available. In some cases, the criteria may include a change in spending or loans in greater than a threshold number or numbers (e.g., different thresholds for different types of accounts, such as a first threshold limit for a checking or credit card account, a different higher threshold for a home equity line of credit, etc.).

The data classification system 142 may obtain this data and classify or categorize the data into one of a number of different categories. In some cases, the categories may correspond to one or more of the various factors 114. In other cases, the categories may be different such that a mapping between categories and what data in the categories gets input into different categories may be provided. More details on which data is mapped to which categories, and how those categories are used to determine each of the financial factors will be described in reference to each factor, in reference to FIGS. 3-9 below. In some cases, the UI 108 may interface with the data classification system 142 to enable a user to view which types of information go into which categories and are used to determine which factors. In yet some cases, the UI 108 may provide for selection items to enable a user to manually categorize certain pieces of financial data and/or recategorize or classify the data. In yet some cases, one piece of data (e.g., a credit card balance), may be categorized in multiple categories. In this case, the balancing/weighting process 144 may be used to ensure that a data point that is used to determine multiple factors does not overly affect the FHS (e.g., such that a weighting between two factors that use the same data point do not contribute more than another single factor would).

In some cases, the evaluation service 102 may also include or provide an FHS simulator 134, which may interface with UI 108 to enable a user to change certain scores for individual factors, certain inputs for certain data points, simulate additional purchases or debt reduction strategies and the like, whereby the FHS simulator 134 will output the resulting FHS. The FHS simulator 134 may provide more transparency in the evaluation process and may enable users to meaningfully and effectively change spending and other financial habits to improve their financial health.

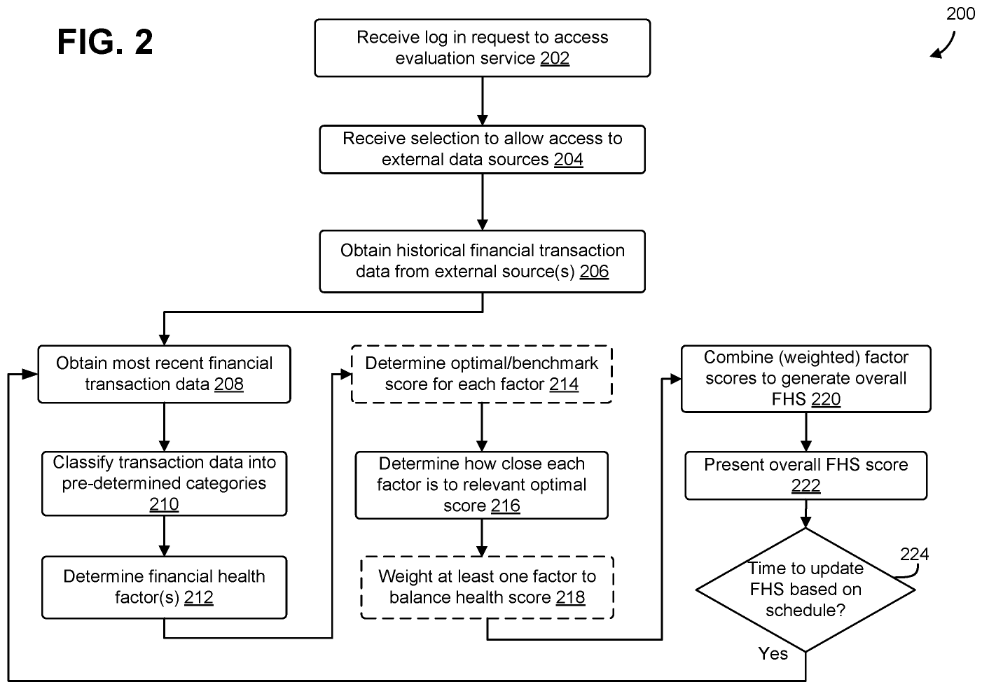

FIG. 2 illustrates an example process 200 for generating a financial evaluation or financial health score (FHS) for a consumer or entity, which may be performed by various components of the evaluation service 102 described above in reference to FIG. 1. As used throughout this disclosure, dashed or dotted lines may indicate optional operations of components of the described systems and techniques, such that the system or the process may be performed with or without the indicated component or operation.

Process 200 may begin with an initialization procedure, as detailed in the first three operations 202, 204 206. The consumer may sign up to receive a FHS and may agree to allow a data accessing entity (e.g., the evaluation service 102 or a service acting on behalf of the evaluation service 102) to access their financial data sources. From the evaluation service perspective, the evaluation service 102 may receive a log in request to access various features provided by evaluation service 102, at operation 202. The evaluation service 102 may validate the log-in credentials via various known techniques, and may have additional data security factors implemented on top of normal username/password type implementations (e.g., two factor authentication, and so on). The evaluation service 102 may also, at operation 204, receive a selection to enable access to various external data sources on the consumer or user's behalf. After gaining access, the data accessing entity/evaluation service 102 may download or otherwise obtain historical financial data/transactions from various data sources (e.g., credit bureaus, credit card providers, banks, auto loan provides, mortgage providers, etc.), at operation 206, which can allow the creation of a financial health score for the downloaded time period. Most financial institutions allow access to at least 2 years of financial data/transactions so a consumer can get their financial health score for the last two years. In some cases, particularly with respect to the payment history factor, access to 2 years of prior data is preferred to give an accurate picture of a consumer's financial health.

The remaining operations of process 200 may, in some examples form a loop, such that upon a given schedule or upon detection of a triggering event, process 200 may loop through operations 208-224 to determine a new or update an existing financial health score. The update schedule can be anywhere from daily to monthly to quarterly (or even yearly), and may include data from only the current time period, or may implement a rolling window, where new data is added and the oldest data discarded, for a longer period (e.g., update schedule is every month, but data is used from the past six months, which includes the current month). In some examples, each of the steps may be completed to correctly update the financial health score, but in some examples, one or more steps may be absent or additional steps may be present.

At operation 208, the most recent financial data/transactions can be obtained or downloaded from the various data sources. The data obtained at operation 208 may then be classified into one of a predetermined set of financial health score data categories that pertain to at least one of the six factors, at operation 210. Once some or all financial transactions have been properly classified, the formulas or induvial processes for each of the financial health score factors can be applied, at operation 212. More detailed examples of how to determine the various financial health factors, which include a liquid reserves factor, a debt-to-income factor, a total spending factor, a payment history factor, a savings factor, and a debt portfolio/debt factor, will be described in greater detail below in reference to FIGS. 3-9. In some optional cases, an optimal or benchmark score for one or more of the factors may be determined at operation 214. In other cases, the benchmark or optimal score may be determined or obtained from elsewhere, such as calculated by another entity, derived from a credit bureau, etc. In some cases, the benchmark or benchmark values for evaluating a factor score is universal, such that the same benchmarks apply to all entities and consumers, etc., to ensure fairness in the FHS. In other cases, different benchmarks may be determined for different user groups having similar characteristics, such as may be defined by age group, occupation, place of residence, and so on.

Next, at operation 216, the scores for one or more of the factors may be compared to one or more benchmarks or optimal scores for that particular factor. This may include comparing any numerical score with one or more numerical benchmarks, for example. In some cases, each factor may be scored or evaluated out of 100, 10, or any other number. In some embodiments, ensuring that the formulas are balanced can be desirable to safeguard the financial health score against manipulation. As described in more detail below, some embodiments can make sure the financial health score is balanced, such as by weighting different factors in the evaluation based on, for example, one or more values with other factors, at operation 218. Operation 218 may be optional in some cases.

In some cases, once any weighting has been performed, the weighted (or unweighted in other cases) scores for each factor may be combined to generate an overall financial health score or FHS, at operation 220. The FHS score may then be returned or presented to a client device, such as through a graphic user interface provided on the client device, through a textual notification or email, etc., at operation 222. Next at operation 224, it may be determined if an event has occurred to cause process 200 to loop back to operation 208 and perform operations 208-224 to update the FHS. In some cases, the triggering event may be the passage of time, such as when the update is set to a schedule. In some cases, a time window may be analyzed to determine the FHS, such as 1 month, 3 month, 6 months, etc. In other cases, a rolling time window may be used such that when new financial data is obtained at operation 208, the previous period of financial data may be discarded or no longer used to determine the FHS score. For example, with a 6 month rolling time window, a new month's data may be collected and analyzed with the past 5 months, whereby the oldest month of data may be removed from the analysis.

Various embodiments of process 200 can provide consumers and lenders an objective, measurable score of the financial health of the consumer by taking into account all of the consumer's relevant financial data. Another novel aspect of some examples is that process 200/evaluation service 102 may quickly, and in some cases, instantly, build up a history of the consumer's financial health while also keeping track of the FHS on an on-going basis so both the consumer and lenders can follow how well the consumer is handling their finances. No other commercially available scores can presently give a consumer or lender this capability.

In some cases, in order to create the financial health score for a consumer, it can be desirable to have access to various financial and other data sources such as e.g., all banking accounts, credit/debit card accounts, investment accounts, debt/loan accounts, etc. In various examples, some or all of these data sources are owned by the consumer and cannot be accessed without the expressed approval of the consumer. To be able to access the data sources, the consumer may be prompted to consent to allow access to the data gathering entity (e.g., the evaluation service 102) to create the financial health score (on a e.g., daily/weekly/monthly basis). In some examples, the data will have to be secured according to the Fair Credit Reporting Act and any pertinent federal, state, and local regulations to ensure the data cannot be accessed by any other party (e.g., other than the party creating the Financial Health Score).

Also, in order to ensure an accurate financial health score, in various embodiments it can be desirable to have some type of verification that all accounts associated with a given user or entity have been identified and access to financial data from those sources is up to date. In some cases, omitting even a single data source can seriously impact the veracity of the financial health score in some embodiments. E.g., a missed credit card with a lot of outstanding debt and serious delinquencies may produce an inaccurate or incomplete financial health score, such that the generated score may be better than the actual financial health score (incorporating the missing data source).

In some cases, ensuring that all accounts have been identified and all data obtained is accurate may be the responsibility of the evaluation service 102. In various examples, the data sources can be accessed in an electronic and/or automated fashion. In such a case, it can be desirable to create interfaces to each financial data source a consumer might utilize. Maintaining both the interfaces and the access to the data sources can be desirable in various examples to ensure the financial health score can be (e.g., automatically) updated on a regular basis. Interfaces to these data sources may be custom implemented, such as in the case of obscure loan providers, or may be more standardized interfaces, such as those typically used to access credit card and other accounts provided by larger banks, etc.

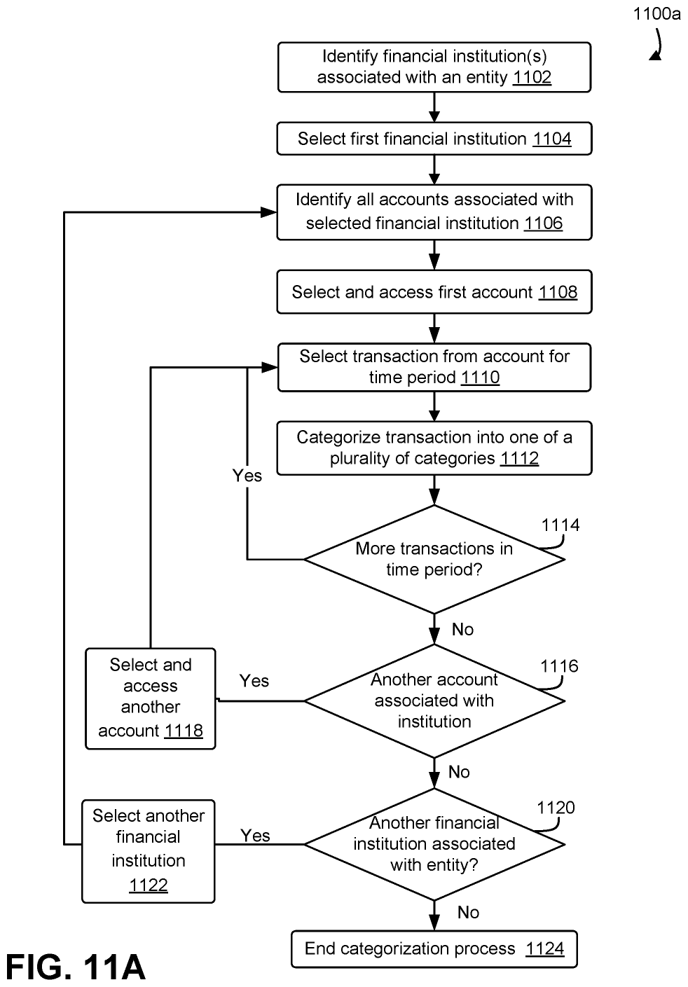

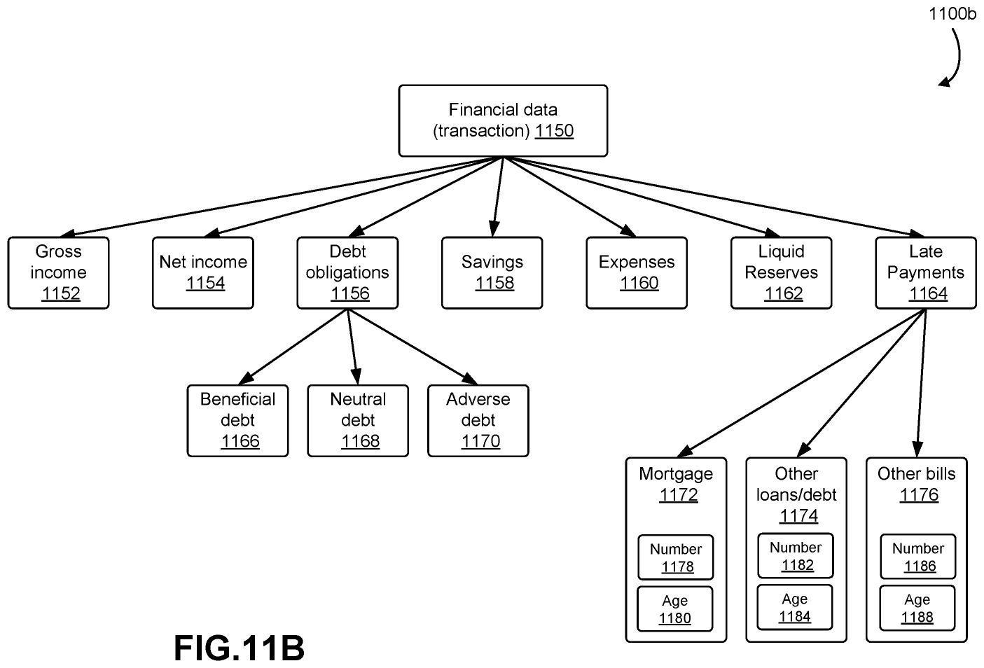

Another novel approach of various embodiments can be to classify all the relevant (financial) data into the appropriate data categories necessary to calculate the Financial Health Score. More detail concerning processes to categorize data will be described in greater detail below in reference to FIG. 11. Since the consumer can own some or all this data, various embodiments can allow the consumer to view the result of the classification and potentially “re-classify” the items to ensure we have the correct classification for each transaction/data item. Some examples can allow the consumer to split one data item into several different (data) categories. In various examples, automating this classification can be desirable to ensure a consistent and efficient classification.

Once the process of (i) getting the consumer's consent to access their data, (ii) ensuring the completeness of data sources for the consumer, (iii) automating the interface of accessing the consumer's relevant financial data, and (iv) automating the classification of each transaction/data item has been completed, in various examples the consumer's financial health score can be calculated on a regular basis. Whether this regular basis is daily, weekly, monthly, or some other schedule can be dependent on several factors and will be addressed below. It is important to note however that in various embodiments the data sources can have different “schedules”; e.g., salary can be weekly, bi-weekly, twice a month, or monthly, property taxes are normally twice a year, garbage can be once every two months, etc. If the financial health score is calculated on, say, a daily basis, in some examples there is a very good chance the score can fluctuate wildly from one day to the next. Finding a “good” schedule for calculating the financial health score can therefore be desirable in some embodiments. In these situations, it can be desirable to determine an average score over a longer time period, such as six months, to account for the different schedules of some bills (e.g., property taxes, bonuses, large purchases, etc.), such as using a rolling time period. In some cases, the period for recalculating the FHS and/or the time frame from which data is obtained may be particularly determined or tuned for individual consumers, or may be objectively set such to account for these different schedules universally and similarly for all users of the evaluation service 102.

Once the relevant financial data has been collected and classified, the evaluation service 102 in various examples can be ready to calculate the consumer's financial health score. The way the financial health score is determined in various embodiments can be through a novel approach whereby the consumer is rated on each of a different set of (financial) factors before the overall financial health score is determined by a weighted sum of all the factors.

For the financial health score, in some examples, factors that highlight the totality of a consumer's financial picture may be used. For some or all of the factors, one or more healthy or benchmark scores can be determined that would constitute a financially healthy score. The consumer's score for each factor can then be measured against the benchmark for that particular factor. In some cases, the factor and the corresponding healthy score is pre-determined (e.g., based on solid financial research), every consumer can be rated objectively against the healthy score in various embodiments. There are no other financial scores that presently perform such an objective rating. In contrast, credit scores do their scoring based on how other consumers (i.e., “peers”) are doing resulting in a score that is biased based on which peer group the consumer “belongs” to. In some cases, by setting objective benchmarks for each factor, a more objective financial evaluation can be determined, thus removing bias from existing systems that rely on a pre-categorization step of the consumer to determine what to compare the consumer to, to provide more equity and fairness for institutions making lending decisions, etc.

In various embodiments, it can be desirable for the financial health score factors to cover the entire financial picture of a consumer to provide a complete/holistic financial view. To achieve this goal, in some examples the factors used to calculate a consumer's financial health score can include, but are not limited to, the following: Debt-to-income, Liquid Reserves, Total Spending, Savings, Debt Portfolio/Debt, and Payment History. Each of these example factors will be described in greater detail below.

FIG. 3 illustrates an example process 300 for determining a debt-to-income factor, such as may be performed by the evaluation service 102 described above in reference to FIG. 1 and/or used in the financial evaluation process 200 described above in reference to FIG. 2. In some cases, process 300 may be performed by the debt-to-income factor processes 118 described above in reference to FIG. 1.

One element that can be used when evaluating a consumer's finances is the debt-to-income ratio. In some cases, it can be calculated as the ratio between a consumer's (monthly) debt payments and (monthly) (gross or net) income. This ratio in various examples can provide significant information about a consumer's present debt burden while also indicating whether a consumer can potentially take on more debt.

As illustrated in FIG. 3, process 300 may begin at operations 302 and 306, where a consumer's (gross/net) income and debt obligations may be obtained, such as from various external data sources 106. In various embodiments, a consumer's debt-to-income ratio may be determined at operation 310, using the income and debt values 304, 308. It should be appreciated that income may include any sources of income, not just a salary from employment, such as rent income, investment income, etc. The consumer's debt-to-income ratio may be calculated as the ratio between the consumer's debt obligations versus gross/net income. In some cases, this ratio may be used directly as the debt-to-income factor, such that operation 312 is bypassed or does not change the value of the ratio determined at operation 310. In other cases, the ratio may be adjusted or modified at operation 312, as described in greater detail below, such as by comparing the determined ratio to one or more bands or ranges of benchmarked values to then determine a score from 0-100. In either case, the debt-to-income ratio or factor may then be stored/returned to the FHS calculator 110 to be used in generating a financial health score, at operation 314.

In some cases, operations 302-314 may be performed on a monthly (or other periodic) basis, such as may be initiated by the scheduler 132 of evaluation service 102. In other examples, the schedule may be set at various other values or time frames, including any schedule that makes sense (e.g., daily, weekly, monthly, quarterly, etc.). It can be desirable in some examples for these values to be downloaded directly from the consumer's own financial sources to minimize any potential errors, as downloading from a third-party data source can be fraught with inaccuracies as highlighted by the “credit data” from the credit bureaus.

For the data used in this calculation, in various examples it can be desirable for the gross/net income to contain all active and passive income streams (e.g., salary, rental income, commissions, bonuses, alimony/palimony income, social security income, retirement income, etc.). Items like dividends, investment income, and annuities can also be part of the consumer's gross/net income. Likewise, the debt obligation portion can be the combination of a consumer's debt payments; this can contain items like mortgage payments, home equity line of credit (HELOC) payments, child support, alimony/palimony payments, credit card payments, and loan payments (whether the loan is tied to an asset or not).

In order to calculate the consumer's debt-to-income factor at operation 312, various embodiments can determine how well the consumer is doing with regards to their debt-to-income ratio. In order to do this, in some examples, an ideal or benchmark debt-to-income ratio may be determined based on sound financial principles. As an example, a common rule of thumb with regards to debt load is the 28/36 rule. According to this example rule, no more than 28% of the gross income should be spent on mortgage(s) while the total debt burden should be no more than 36% of the gross income. As the ultimate goal here can be to measure a consumer's financial health, the debt-to-income ratio in various examples needs to be low enough that the consumer can live within their means but also low enough that the consumer can potentially take on new debt without getting into financial distress. Using this example, a healthy debt-to-income ratio of one example should be lower than 36% but also low enough to allow the consumer to have some financial room to e.g., take on new debt and handle unforeseen expenses (e.g., job loss, medical expenses, etc.). In this example, the ideal debt-to-income ratio should therefore be somewhere between 22% to 32%. If the consumer's debt-to-income ratio is equal to the ideal debt-to-income ratio—or lower, the debt-to-income actor may be determined to be a perfect score (e.g., 10/10, 100/100, etc.) for the debt-to-income factor in various embodiments.

In some embodiments, it can be desirable to determine if there is a lower limit for the debt-to-income factor. Using the same 28/36 rule example as above, the consumer's debt-to-income ratio should ideally be no more than 36%. Since consumer's financial situations are different, there may be cases where a higher debt-to-income ratio than 36% may still be allowed. In this example, an alternative maximum debt-to-income ratio could be somewhere between 40% and 60%. In various examples, if the consumer's debt-to-income ratio is equal to the “maximum allowed” debt-to-income ratio—or higher, the consumer would be allocated a zero score for their debt-to-income factor.

Some examples can consider if the debt-to-income factor should be linear between these end points (e.g., the ideal ratio and the maximum allowed ratio) or if some other type of mathematical equation may be used to determine the debt-to-income factor. Various alternative equations or relationships may include linear, quadratic, cubic, hyperbolic, logarithmic, etc. Various embodiments can encompass and allow for the use of any suitable mathematical equation to determine the debt-to-income factor.

In various examples, if the consumer's debt-to-income ratio is at, or below, the ideal ratio, the consumer's debt-to-income factor may be determined to be 100% (e.g., a perfect score). In various examples, if the consumer's debt-to-income ratio is at, or above, the “maximum allowed” ratio, the consumer's debt-to-income factor should be 0%. In some embodiments, the debt-to-income factor may be separated into separate or different bands, such that various values between 0% and 100% may be used. Accordingly, some embodiments can include dividing up the scale between 0% and 100% (debt-to-income factor) into any suitable number of bands and using any suitable type of mathematical equation in each band.

For example: in one illustrative embodiment, the ideal debt-to-income ratio may be set at 25% and the maximum allowed debt-to-income ratio is 55%. This implies the consumer's debt-to-income factor will be 100% if their debt-to-income ratio is 25% or lower, and 0% if their debt-to-income ratio is 55% or higher. The score may be divided between 25% (debt-to-income ratio) and 55% (debt-to-income ratio) into three example bands as follows. In a first example, if the debt-to-income ratio is greater than or equal to 25% and less than 35%, then the debt-to-income factor will go from 100% (if the debt-to-income ratio is equal to 25%) to 50%. In another example, if the debt-to-income ratio is greater than or equal to 35% and less than 40%, then the debt-to-income factor will go from 50% (if the debt-to-income ratio is equal to 35%) to 25%. In yet another example, if the debt-to-income ratio is greater than or equal to 40% and less than 55%, then the debt-to-income factor will go from 25% (if the debt-to-income ratio is equal to 40%) to 0%.

In such an example, if the debt-to-income ratio is less than 25% the debt-to-income factor would be 100% and if the debt-to-income ratio is greater than 55% the debt-to-income factor would be 0%. Continuing on the example, the following formulas for creating the debt-to-income factor may be selected: if the debt-to-income ratio is greater than or equal to 25% and less than 35%, then use a linear formula to calculate the debt-to-income factor; if the debt-to-income ratio is greater than or equal to 35% and less than 40%, then use a logarithmic formula to calculate the debt-to-income factor; and if the debt-to-income ratio is greater than or equal to 40% and less than 55%, then use a quadratic formula to calculate the debt-to-income factor.

Various embodiments can allow for the maximal flexibility, so in some examples it can be desirable to select the most appropriate bands and formula for each band to make sure to measure the true financial health of the consumer. This approach can be highlighted further with a general example using a simple linear formula. Given an initial set of values:
Healthiest ratio=the Debt-to-income ratio that will give the highest Debt-to-income factor in the band
Unhealthiest ratio=the Debt-to-income ratio that will give the lowest Debt-to-income factor in the band
Max score=the maximum Debt-to-income factor in the band
Min score=the minimum Debt-to-income factor in the band
Score range=Max score−Min score
Value=the consumer's Debt-to-income ratio (must, of course, be within the band)
Step=1/ABS(Healthiest ratio—Unhealthiest ratio), where ABS(x) is the absolute value of x
Relative ratio=AB S(Healthiest ratio−Value)
   To calculate the consumer's debt-to-income factor, the following formula may be used:

Debt-to-income factor=Max score−(Relative ratio*Step*Score range)

If the consumer has a Debt-to-income ratio of 30% and using the example above, the results are:
Healthiest ratio=25
Unhealthiest ratio=35
Max score=100
Min score=50
Score range=100—50=50
Value=30
Step=1/ABS(25−35)=1/10=0.1
Relative ratio=ABS(25—30)=5
Debt-to-income factor=100−(5*0.1*50)=100−25=75, i.e., 75%

In other examples, another formula (e.g., a quadratic formula or other formula, equation or relationship), may be used to determine the Debt-to-income. As discussed herein, these are merely examples in accordance with some embodiments, so these example embodiments should not be construed to be limiting.

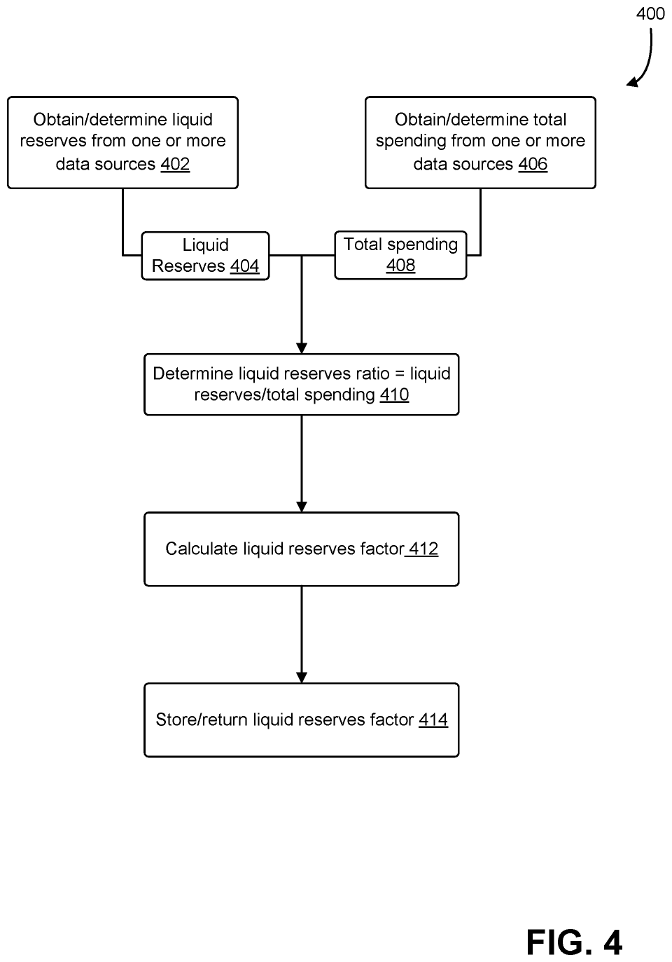

FIG. 4 illustrates an example process for determining a liquid reserves factor, such as may be performed by the evaluation system 100 described above in reference to FIG. 1 and/or used in the financial evaluation process 200 described above in reference to FIG. 2. In some cases, process 400 may be performed by the liquid reserves factor processes 116 described above in reference to FIG. 1.

When determining if a consumer is financially healthy or not, in various embodiments it can be desirable to take into consideration how well the consumer can handle a financial hardship. There are many potential unexpected financial issues a consumer can face, e.g., a loss of income/job, medical emergency (whether or not the consumer has insurance), needing a new commute car, etc., but also things outside of the consumer's control like a national financial crisis or global pandemic. The problem with such financial emergencies is that the consumer's spending will (normally) stay about the same and those bills will have to be paid on a regular basis regardless (or the consumer can risk losing their home, get their car repossessed, etc.).

In order to deal with a financial shortfall, the consumer should have liquid reserves available such that all expenses/spending can continue to be paid. Such reserves must be truly liquid, i.e., the consumer should be able to withdraw money from their liquid accounts without penalty and without (a significant) delay. The amount of liquid reserves available should be measured as a factor of the consumer's spending—which is what is necessary for the consumer to sustain their current obligations and expenditures.

As the example flow chart indicates, process 400 can include downloading or otherwise obtaining the consumer's (e.g., total) liquid reserves and total spending at operations 402 and 406. Some embodiments can calculate the consumer's available liquid reserves on a monthly basis, which means in some examples we can download the consumer's total liquid reserves and monthly total spending, but the schedule (for the total spending) can be any schedule that makes sense (e.g., daily, weekly, monthly, quarterly, etc.). When it comes to liquid reserves, in some examples it has no meaning to look at the monthly (or any other schedule) liquid reserves but rather the consumer's total liquid reserves as these are the (e.g., liquid) reserves available at the given moment. It can also be desirable in some embodiments that these values are downloaded directly from the consumer's own financial sources in order to minimize any potential errors, downloading from a third-party data source can be fraught with inaccuracies as highlighted by the “credit data” from the credit bureaus. The consumer's liquid reserves ratio can then be calculated in various examples as the ratio between the consumer's liquid reserves versus total spending (e.g., as shown in the example flow chart), at operation 410. Once this ratio is determined, in various embodiments, the consumer's liquid reserves factor can be determined at operations 412, and stored (e.g., along with the Liquid Reserves and Total Spending) in a safe and secure location so it can be used to show the consumer's historical financial health, at operation 414.

For the data used in this calculation, in various embodiments it can be desirable for the liquid reserves value 404 to contain assets from all accounts that are truly liquid, i.e., the consumer should be able to withdraw money from their liquid accounts without penalty and without (a significant) delay. Likewise, in various examples the total spending portion or value 408 can be the combination of a consumer's non-discretionary and discretionary spending; this can contain items like debt obligations (see above), rent(s), water/sewer, gas/electricity, etc. (normally considered non-discretionary expenses) but also items like theater visits, vacation expenses, personal gifts, hobbies, etc. (normally considered discretionary spending).

In order to calculate the consumer's liquid reserves factor, at operation 412, in some examples, how well the consumer is doing with regards to their available liquid reserves ratio can be determined, as this measures how long the liquid reserves will “sustain” the consumer in the event of a (financial) hardship. In order to do this, various embodiments can determine an ideal or benchmark liquid reserves ratio based on sound financial principles. There are differing opinions as to how many (for example) months of total spending a consumer should have available (e.g., to deal with a financial shortfall) to be considered financially healthy. In some examples, such a value can be considered to be anywhere from 3 months to 24 months (or even more in certain circumstances). As an example, the ideal or benchmark liquid reserves ratio may be determined to be somewhere between 6 and 12. If the consumer's liquid reserves ratio is equal to the ideal liquid reserves ratio—or higher, the consumer can get a perfect score for the liquid reserves factor in various example.

Various embodiments can determine if there is a lower limit for the liquid reserves factor. For example, in some embodiment, if the consumer has no liquid reserves available, the consumer should get a zero score for their liquid reserves factor. Notice, however, that in some examples the lower limit can just as easily be set at a positive number to require a minimum number of months of liquid reserves available before the consumer will get a positive liquid reserves factor.

Some embodiments can consider if the liquid reserves factor should be linear between these end points (i.e., the ideal ratio and “not enough available liquid reserves”) or if we should use some other type of mathematical equation to determine the liquid reserves factor. There are many types of equations that would make sense in this scenario (e.g., linear, quadratic, hyperbolic, logarithmic, etc.), but various embodiments encompass and allow for the use of any suitable mathematical equation to determine the liquid reserves factor.

In various examples, if the consumer's liquid reserves ratio is at, or above, the ideal ratio, the consumer's liquid reserves factor would be determined to be 100% (e.g., a perfect score). If the consumer's liquid reserves ratio is at (or maybe even below) 0 (zero), the consumer's liquid reserves factor would be 0%. In some embodiments, it can be desirable to divide up the (liquid reserves) factor into separate “bands” and not use one “band” between 0% and 100%. Various embodiments encompass and allow for dividing up the scale between 0% and 100% (liquid reserves factor) into any suitable number of bands or ranges and using any suitable type of mathematical equation in each band.

In one example, the ideal liquid reserves ratio is set to be 6 (months) and the minimum liquid reserves ratio is 1 (month); that can mean the consumer's liquid reserves factor will be 100% if their liquid reserves ratio is 6 or higher, and 0% if their liquid reserves ratio is 1 or lower. We could potentially divide the score between 6 (liquid reserves ratio) and 1 (liquid reserves ratio) into two bands as follows: if the liquid reserves ratio is greater than or equal to 1 (month) and less than 4 (months), then the liquid reserves factor will go from 0% (if the liquid reserves ratio is equal to 1) to 90%, and if the liquid reserves ratio is greater than or equal to 4 (months) and less than 6 (months), then the liquid reserves factor will go from 90% (if the liquid reserves ratio is equal to 4) to 100%.

In such an example, if the liquid reserves ratio is less than 1 the liquid reserves factor would be 0% and if the liquid reserves ratio is greater than 6 the liquid reserves factor would be 100%. continuing the example, the following may be selected for the formulas for creating the liquid reserves factor: if the liquid reserves ratio is greater than or equal to 1 (month) and less than 4 (months), then use a linear formula to calculate the liquid reserves factor, and if the liquid reserves ratio is greater than or equal to 4 (months) and less than 6 (months), then use a hyperbolic formula to calculate the liquid reserves factor.

Since various embodiments can allow for the maximal flexibility, it can be desirable in some examples to select “the most appropriate” bands and formula for each band to make sure to measure the true financial health of the consumer. In one general example, a simple linear formula may be sued. Example values may be defined as:
Healthiest ratio=the Liquid Reserves ratio that will give the highest Liquid Reserves factor in the band
Unhealthiest ratio=the Liquid Reserves ratio that will give the lowest Liquid Reserves factor in the band
Max score=the maximum Liquid Reserves factor in the band
Min score=the minimum Liquid Reserves factor in the band
Score range=Max score−Min score
Value=the consumer's Liquid Reserves ratio (must, of course, be within the band)
Step=1/ABS(Healthiest ratio—Unhealthiest ratio), where ABS(x) is the absolute value of x
Relative ratio=AB S(Healthiest ratio—Value)
   To calculate the consumer's liquid reserves factor, in various embodiments, the following formula may be used:

Liquid Reserves factor=Max score−(Relative ratio*Step*Score range)

If the consumer has a Liquid Reserves ratio of 3 and using the example above, we get:
Healthiest ratio=4
Unhealthiest ratio=1
Max score=90
Min score=0
Score range=90−0=90
Value=3
Step=1/ABS(4−1)=1/3
Relative ratio=ABS(4−3)=1
Liquid Reserves factor=90−(1*1/3*90)=90−30=60, i.e., 60%

If another formula (e.g., a quadratic, cubic, logarithmic, hyperbolic, etc.) is selected, the liquid reserves factor could, of course, be different. As discussed herein, these are merely examples in accordance with some embodiments, so these example embodiments should not be construed to be limiting.

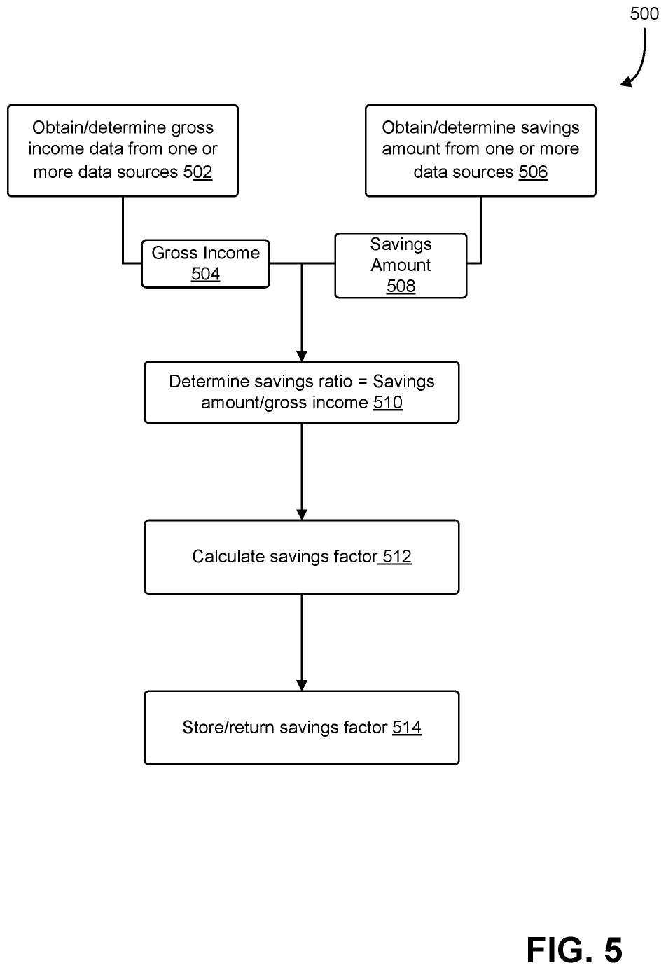

FIG. 5 illustrates an example process for determining a savings factor, such as may be performed by the evaluation system 100 described above in reference to FIG. 1 and/or used in the financial evaluation process 200 described above in reference to FIG. 2. In some cases, process 400 may be performed by the savings factor processes 124 described above in reference to FIG. 1.

The idea of “pay yourself first” can be to have a strategy for consistent savings (and investments) in order to build wealth, and to do that by making sure some income goes to savings (i.e., pay yourself first, then pay your bills). It also promotes good, stringent financial practices and is another sign of a healthy financial life.

The savings factor can measure how well a consumer meets the goal of (active) savings. The amount of (active) savings can be measured in some examples as a factor of the consumer's gross income or net income, and various embodiments encompass and allow for either. For the sake of simplicity, the example of using a consumer's gross income will be described in greater detail below, but this specific example should not be construed to be limiting.

As the example flow chart indicates, process 500 may include downloading or otherwise obtaining the consumer's gross income and savings amount at operations 502 and 506. Some embodiments can calculate the consumer's Savings ratio on a monthly basis, which means in various examples we can download the consumer's monthly gross income and monthly savings amount (e.g., the amount of money the consumer has added to their savings/investments accounts this month), but the schedule can be any schedule that makes sense (e.g., daily, weekly, monthly, quarterly, etc.). It can be desirable in some embodiments for these values to be downloaded directly from the consumer's own financial sources in order to minimize any potential errors, downloading from a third-party data source can be fraught with inaccuracies as highlighted by the “credit data” from the credit bureaus. The consumer's savings ratio can then be calculated at operation 510, for example, as the ratio between the consumer's savings amount versus gross income (as shown in the flow chart). Using this ratio, in various examples, the consumer's savings factor may be determined at operation 512, and storing (along with the gross income and Savings amount) in a safe and secure location so it can be used to show the consumer's historical financial health, at operation 514.

For the data used in this calculation, it can be desirable for the gross income 504 to contain all active and passive income streams (e.g., salary, rental income, commissions, bonuses, alimony/palimony income, social security income, retirement income, etc.). Items like dividends, investment income, and annuities can also be part of the consumer's gross income. Likewise, the Savings amount 508, in some examples, may be the combination of the amount(s) (of money) the consumer adds to their savings or investment accounts; this can contain accounts like savings account(s), 401K accounts, all types of IRA accounts, any other investment accounts, etc.

In order to calculate the consumer's Savings factor at operation 512, various embodiments can determine how well the consumer is doing with regards to their savings ratio. In order to do this, in some embodiments, one or more ideal or benchmark savings ratio may be determined based on sound financial principles. In some examples, an ideal savings ratio can be defined as somewhere around 10% (of gross income). Allowing for differences in consumers' ability to save, an ideal Savings factor in further examples can be somewhere between 2% and 20%.

Various embodiments can determine if there is a lower limit for the savings factor. In some embodiments, if the consumer does not save anything (e.g., during the timeframe in question), the consumer would be assigned a zero score for their savings factor. In some embodiments, the lower limit can be set at a positive number to require a minimum amount of savings before the consumer will get a positive savings factor.

Various embodiments can consider if the savings factor should be linear between these end points (i.e., the ideal ratio and the not enough savings ratio) or if some other type of mathematical equation should be used to determine the savings factor. There are many types of equations that would make sense in this scenario (e.g., linear, quadratic, hyperbolic, logarithmic, etc.), but various examples encompass and allow for the use of any suitable mathematical equation to determine the savings factor.

In various embodiments, if the consumer's savings ratio is at, or above, the ideal ratio, the consumer's savings factor should be 100% (e.g., a perfect score). If the consumer's savings ratio is at, or below, the “not enough savings” ratio, the consumer's savings factor can be 0% in various embodiments. Some embodiments can divide up the savings factor into separate bands or ranges and not use one band between 0% and 100%. Various embodiments encompass and allow for dividing up the scale between 0% and 100% for the savings factor into any suitable number of bands and using any suitable type of mathematical equation in each band.

For example, in one embodiment, the ideal Savings ratio may be determined to be 10% and the not enough Savings ratio may be 0%; that means the consumer's savings factor will be 100% if their Savings ratio is 10% or higher, and 0% if their savings ratio is 0% (or lower if that is possible). In this example, only one band may be used (e.g., as the savings ratio goes between 0% and 10%, the savings factor will go from 0% to 100%).

In such an example, if the savings ratio is less than 0% the savings factor would be 0% and if the Savings ratio is greater than 10% the savings factor would be 100%. Continuing the example, we could choose a linear formula to calculate the savings factor.

Since various embodiments allow for the maximal flexibility, it can be desirable in some examples to select “the most appropriate” bands and formula for each band to make sure to measure the true financial health of the consumer.

In a first general example, a simple linear formula may be used. Some example values may be defined as follows:
Healthiest ratio=the Savings ratio that will give the highest Savings factor in the band
Unhealthiest ratio=the Savings ratio that will give the lowest Savings factor in the band
Max score=the maximum Savings factor in the band
Min score=the minimum Savings factor in the band
Score range=Max score−Min score
Value=the consumer's Savings ratio (must, of course, be within the band)
Step=1/ABS(Healthiest ratio—Unhealthiest ratio), where ABS(x) is the absolute value of x
Relative ratio=ABS(Healthiest ratio−Value)
   To calculate the consumer's Savings factor, the following formula may be used:

Savings factor=Max score−(Relative ratio*Step*Score range)

If the consumer has a savings ratio of 3.6% and using the example above, the following values may be determined:
Healthiest ratio=10
Unhealthiest ratio=0
Max score=100
Min score=0
Score range=100−0=100
Value=3.6
Step=1/ABS(10−0)=1/10=0.1
Relative ratio=ABS(10−3.6)=6.4
Debt-to-income factor=100−(6.4*0.1*100)=100−64=36, i.e., 36%

In other examples, another formula or formulas may be used (e.g., a quadratic, cubic, hyperbolic, logarithmic, etc.), where the savings factor would be determined differently. As discussed herein, these are merely examples in accordance with some embodiments, so these example embodiments should not be construed to be limiting. In other examples, two or more bands may be selected for savings, whereby each band may be determined using the same or a different formula.

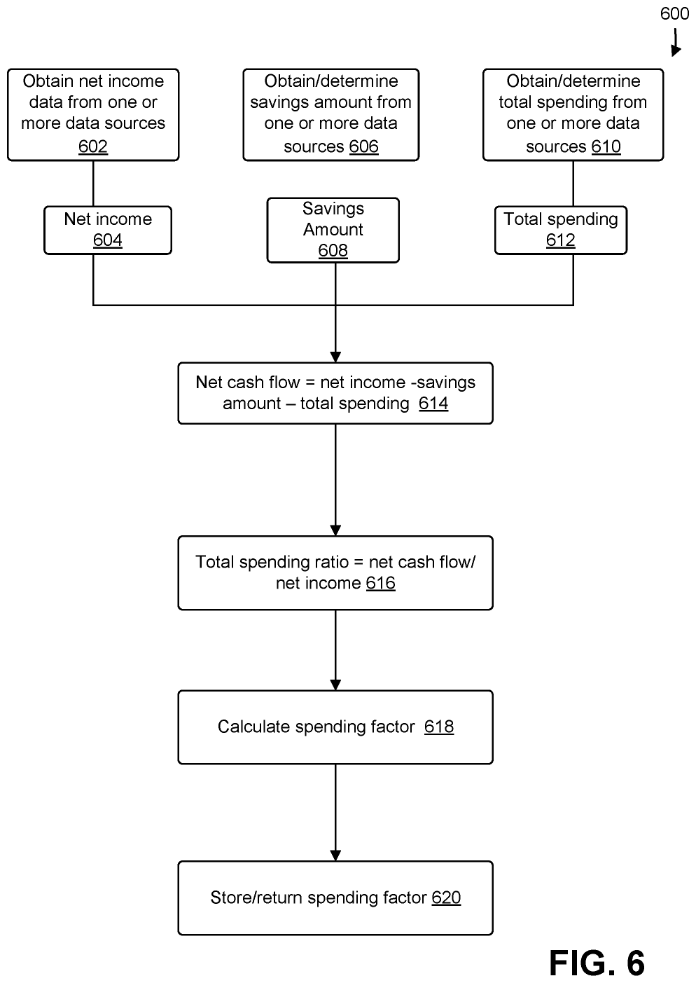

FIG. 6 illustrates an example process for determining a total spending factor, such as may be performed by the evaluation system 100 described above in reference to FIG. 1 and/or used in the financial evaluation process 200 described above in reference to FIG. 2. In some cases, process 600 may be performed by the total spending factor processes 120 described above in reference to FIG. 1.

For a consumer to be financially healthy and have (financially) healthy habits, in various examples it can be desirable for the consumer to live within their means. This may simply mean that the consumer should spend less on their lifestyle than they generate in earnings. Keeping in mind that the consumer should put money aside in savings (see savings factor), the term net cash flow may be used to measure a customer's spending habits, and may be defined as:

Net cash flow=Net income−Savings amount−Total Spending

where total spending can be defined as all spending a consumer has in the given timeframe (with the exception, for example, of the savings amount put aside in the same timeframe). Total spending can therefore encompass all regularly scheduled bills (things like rent, mortgage, electricity, loan payments, etc.) but also all other spending (things like restaurant meals, car tune-up, hobbies, night school, etc.). The net cash flow can be measured as a factor of the consumer's net income, but the consumer's gross income can alternatively be used in some examples. Various embodiments encompass and allow for using either net income or gross income. For the sake of simplicity, the example of using a consumer's net income will be provided below, but this example should not be construed to be limiting.

As the flow chart indicates, process 600 may include downloading or obtaining the consumer's net income, savings amount, and total spending, at operations 602, 606, and 610. Some embodiments can calculate the consumer's total spending ratio on a monthly basis, at operation 616, which means in some examples, the consumer's monthly net income 604, monthly savings amount (e.g., the amount of money the consumer has added to their savings/investments accounts this month) 608, and monthly total spending 612, but the schedule can be any schedule that makes sense (e.g., daily, weekly, monthly, quarterly, etc.). In some examples, it can be desirable for such values to be downloaded directly from the consumer's own financial sources in order to minimize any potential errors, whereas downloading from a third-party data source can be fraught with inaccuracies as highlighted by the credit data from the credit bureaus. The net cash flow can be calculated as the net income minus savings amount minus total spending, at operation 614. The consumer's total spending ratio can then be calculated as the ratio between the consumer's net cash flow versus net income, at operation 616. Once the ratio has been determined, the consumer's total spending factor can be determined at operation 618, and can stored (along with the gross income, Savings amount, and Total Spending) in a safe and secure location so it can be used to show the consumer's historical financial health, at operation 620.

For the data used in this calculation, in various examples the net income 604 can be the gross income minus taxes for all active and passive income streams (e.g., salary, rental income, commissions, bonuses, alimony/palimony income, social security income, retirement income, etc.). Items like dividends, investment income, and annuities can also be part of the consumer's net income 604 in some examples. Likewise, the savings amount 608 can be the combination of the amount(s) (of money) the consumer adds to their savings or investment accounts; this should contain accounts like savings account(s), 401K accounts, all types of IRA accounts, any other investment accounts, etc. Finally, the total spending 612 can be “all other” spending the consumer has done in the time frame chosen.

In order to calculate the consumer's total spending factor, in various embodiments, it may be determined how well the consumer is doing with regards to their total spending ratio. In order to do this, in some examples, one or more ideal or benchmark total spending ratios or ranges may be determined, based on sound financial principles. In some examples, an ideal total spending ratio can be somewhere between 10% (of net income) and 20%.

Various embodiments can determine if there is a lower limit for the total spending factor. For example, if the consumer's net cash flow is zero (and hence, their total spending ratio is zero) during the timeframe in question, in various examples the consumer should get a zero score for their total spending factor. Notice, however, that in further examples the lower limit can just as easily be set at a positive number (e.g., 10, 12, 200, 500 etc.) to require a positive net cash flow (and hence, a positive total spending ratio) before the consumer will get a positive total spending factor (e.g., the consumer will have to have a net cash flow of more than 10/12/200/etc. in order to get a positive total spending factor).

Various embodiments can consider if the total spending factor should be linear between these end points (e.g., the “ideal” ratio and the “not enough net cash flow” ratio) or if some other type of mathematical equation should be used to determine the total spending factor. There are many types of equations that would make sense in this scenario (e.g., linear, quadratic, hyperbolic, logarithmic, etc.), but various examples encompass and allow for the use of any suitable mathematical equation to determine the total spending factor.

In some examples, if the consumer's total spending ratio is at, or above, the ideal ratio, the consumer's total spending factor should be 100% (e.g., a perfect score). If the consumer's Total Spending ratio is at, or below, the “not enough cash flow” ratio, the consumer's total spending factor can be 0%. In some embodiments, the total spending factor may be divided into separate bands or ranges, and not just one band between 0% and 100%. Various embodiments encompass and allow for dividing up the scale between 0% and 100% total spending factor into any suitable number of bands and using any suitable type of mathematical equation in each band.

For example, in one embodiment, the ideal total spending ratio is 10% and the not enough cash flow ratio is 1%; that means the consumer's total spending factor will be 100% if their total spending ratio is 10% or higher, and 0% if their total spending ratio is 1% (or lower). The score may be divided between 1% (total spending ratio) and 10% (total spending ratio) into two bands as follows: if the total spending ratio is greater than or equal to 1(%) and less than 5(%), then the total spending factor will go from 0% (if the total spending ratio is equal to 1) to 80%; and if the total spending ratio is greater than or equal to 5(%) and less than 10(%), then the total spending factor will go from 80% (if the total spending ratio is equal to 5) to 100%.

As already stated, if the Total Spending ratio is less than 1% the total spending factor would be 0% and if the total spending ratio is greater than 10% the total spending factor would be 100%. Continuing the example, in some cases, the following may be selected for the formulas for creating the total spending factor: if the total spending ratio is greater than or equal to 1(%) and less than 5(%),a linear formula may be used to calculate the total spending factor; and if the total spending ratio is greater than or equal to 5(%) and less than 10(%), then a logarithmic formula may be used to calculate the total spending factor.

Since various embodiments allow for the maximal flexibility, it can be desirable in some examples to select the most appropriate bands and formula for each band to make sure to measure the true financial health of the consumer. This may be highlighted with the following general example, using the following values and a linear formula:
Healthiest ratio=the Total Spending ratio that will give the highest Total Spending factor in the band
Unhealthiest ratio=the Total Spending ratio that will give the lowest Total Spending factor in the band
Max score=the maximum Total Spending factor in the band
Min score=the minimum Total Spending factor in the band
Score range=Max score−Min score
Value=the consumer's Total Spending ratio (must, of course, be within the band)
Step=1/ABS(Healthiest ratio—Unhealthiest ratio), where ABS(x) is the absolute value of x
Relative ratio=AB S(Healthiest ratio−Value)
   To calculate the consumer's total spending factor, the following formula may be used:

Total Spending factor=Max score−(Relative ratio*Step*Score range)

If the consumer has a Total Spending ratio of 1.5% and using the example above, the following values may be obtained:
Healthiest ratio=5
Unhealthiest ratio=1
Max score=80
Min score=0
Score range=80−0=80
Value=1.5
Step=1/ABS(5−1)=1/4=0.25
Relative ratio=ABS(5−1.5)=3.5
Total Spending factor=80−(3.5*0.25*80)=80−70=10, i.e., 10%

In other cases, one or more other formulas may be used (e.g., a quadratic formula, cubic, hyperbolic, logarithmic, etc.). As discussed herein, these are merely examples in accordance with some embodiments, so these example embodiments should not be construed to be limiting.

FIG. 7A illustrates an example process 700a for determining a debt portfolio factor, such as may be performed by the evaluation system 100 described above in reference to FIG. 1 and/or used in the financial evaluation process 200 described above in reference to FIG. 2. In some cases, process 700a may be performed by or may be a specific example of the debt portfolio/debt factor processes 126 described above in reference to FIG. 1.

Another unique approach of some embodiments of the present techniques includes determining a debt portfolio factor, which can consider and classify the types of loans that make up a consumer's debt portfolio. This is in contrast to the debt-to-income factor that can consider the consumer's total debt load. To understand this factor, it is important to note that in various embodiments not all debts are considered equal; e.g., if the interest rate is low enough (e.g., lower than the consumer price index or other objective metric) the loan can be considered beneficial to the consumer. On the other hand, if e.g., the interest rate is high enough it can be considered adverse to the consumer. Debt payments such as alimony/palimony and child support may be considered neutral debt (neither beneficial nor adverse) in some examples.

There are a lot of financial articles describing “good” debt (or beneficial debt) versus “bad” debt (or adverse debt) and how it can influence a consumer's financial health/situation. The major problem is that there is nothing concrete in determining whether a debt is beneficial or adverse. Almost all articles describe how a debt can be beneficial or adverse, but there is no definition we can use to easily determine whether a debt a consumer takes on should be considered beneficial or adverse (or even neutral). This leaves a consumer, or even a financial advisor to the consumer, to make subjective decisions over which debts to take on and how they would impact their financial health. It also makes it impossible to create any mathematical/financial formulas that can incorporate the impact of beneficial/adverse debt on a consumer's financial health. This, in turn, makes it impossible to obtain an objective determination of the consumer's financial health. In light of the foregoing, a need exists for an improved system and method for determining a consumer's beneficial, neutral, and adverse debt in an effort to overcome the aforementioned obstacles and deficiencies. In order to address this need, a novel technique for classifying debt as beneficial or adverse is described below.

The need for having a definition with regards to the beneficial, neutral, or adverse debt of a consumer can come from the need to accurately and objectively assess a consumer's financial health and preferably quantify it in a financial health score, or the like. By having a “mathematical” definition of beneficial, neutral, and adverse debt, various embodiments can enable creating objective financial formulas for making such determinations. To understand this area, it is important to note that in various examples not all debts are equal; e.g., if the interest rate is “low enough” (e.g., lower than the consumer price index) a loan can be considered beneficial to the consumer. On the other hand, if e.g., the interest rate is “high enough” it can be considered adverse to the consumer. Accordingly, in some embodiments it can be desirable to consider the interest rate of the loan/debt. In order to determine a consumer's financial health, in various embodiments, it can be desirable to know which types of debt the consumer has (e.g., beneficial, neutral, adverse) and take this into consideration. For example, beneficial debt can improve a consumer's financial health while adverse debt can worsen it.

Please note that there are “instruments” in the financial industry that do not have an interest rate associated with it. Things like alimony/palimony payments and child support payments do not necessarily have an interest rate, but are, in financial terms, normally considered part of a consumer's debt. Such “instruments” can be considered (“by definition”) neutral debt (i.e., neither beneficial nor adverse).

As interest rates for a consumer's debt can vary (e.g., for a variable rate loan/mortgage, credit cards where the interest rate can be adjusted, etc.), it can be desirable for the consumer's financial health, in some examples, that the amount of adverse debt does not become too large as that would have a negative effect on their finances. A determination that a loan or other debt has “too high” interest rate, as may be classified as adverse by the present techniques, may also be an indication the consumer should consider refinancing their loans/credit or consolidating some of their loans/credit into a loan/credit with a more favorable interest rate.

As interest rates for a consumer's debt can vary (e.g., for a variable rate loan/mortgage, credit cards where the interest rate can be adjusted, etc.) over the lifetime of the debt/loan, in some embodiments it can be desirable for a definition to take this into consideration. Also, since interest rates for new loans/debt can rise and fall (depending on many factors) over time, various embodiments do not use fixed interest rates for the definition. Accordingly, in some embodiments it can be desirable to use a “dynamic” definition that can be generally accepted by the financial industry, a definition that will “automatically” adjust for changing interest rate factors.

There can be several “generally accepted” benchmarks for interest rates and various embodiments encompass and allow for using any of the generally accepted benchmark interest rates. Such generally accepted benchmark interest rates include, but are not limited to, the Federal Funds Rate, SOFR (Secured Overnight Financing Rate), the prime rate, the rate on benchmark U.S. Treasury securities, etc. Most of these rates are not offered to consumers directly but rather to lending institutions so various examples can take this into consideration when defining where the “crossover” is between beneficial, neutral, and adverse debt. Various examples can determine how to define beneficial/neutral/adverse debt. In some cases, the definition may be as follows:

Beneficial debt: Consumer's interest rate<benchmark interest rate+x%;

Neutral debt: benchmark interest rate+x%<=Consumer's interest rate<benchmark interest rate+y%; and

Adverse debt: Consumer's interest rate>=benchmark interest rate+y%

where x and y can be chosen to allow for interest rates the consumer can actually get. In some examples, x can be somewhere between 4 and 7 while y can be probably somewhere between 9 and 12 (depending, for example, on the interest rate the lending institutions add to the benchmark interest rate). In some cases, x and y, and the ultimate ranges of beneficial and adverse debt may vary over time to match the current rate available to consumers. In these examples, either in response to a rate change (such as beyond or greater than a threshold amount), or at the next time interval for determining the FHS, the debt or debt portfolio factor may be recalculated to reflect current conditions. To measure the health of a consumer's debt portfolio, in some examples, the amount of adverse debt may be measured as a factor of either the (amount of) beneficial debt or income. Various embodiments encompass and allow for using either beneficial debt or (gross or net) income.

FIG. 7B illustrates an example process 700b for classifying debt into one of two or more different categories, such as beneficial debt, neutral debt, and adverse debt, such as may be performed by the evaluation system 100 described above in reference to FIG. 1 and/or used in the financial evaluation process 200 described above in reference to FIG. 2. In some cases, process 700b may be performed by or the debt portfolio/debt factor processes 126 described above in reference to FIG. 1. In some cases, process 700b may be performed in addition to process 700a described herein, such that process 700b takes an inputs various debt values or items (e.g., financial data) and classifies them into one of a number of different categories, such as beneficial debt, neutral debt, (which in some cases may be optional), and adverse debt. The output of process 700b may be two or three different sets (in the case neutral debt is used as an additional category to beneficial and adverse debt) of debt information, such may be obtained by operations 702, 706, and/or 710 of process 700a.

In some examples, process 700b may begin at operation 750, in which financial data classified as debt may be obtained. In some cases, financial data may be classified as debt by data classification process 1100a, such as using a data classification scheme 1100b, described above in reference to FIGS. 11A and 11B. Next, at operation 752, benchmark interest rate data may be obtained such as from one or more publicly available data sources, and may include a benchmark interest rate value, such as the Federal Funds Rate, SOFR (Secured Overnight Financing Rate), the prime rate, the rate on benchmark U.S. Treasury securities, or another similar rate, etc. Next, at operation 754, a beneficial debt interest rate threshold may be determined, such as using the benchmark interest rate and, in some cases, adding a first value to that number to represent an actual interest rate available to consumers. At operation 756, an adverse debt interest rate threshold may be determined, such as using the benchmark interest rate and, in some cases, adding a second value to that number to represent an actual interest rate available to consumers. In some cases, the second value may be greater than the first value, such that the adverse interest rate is higher than the beneficial interest rate.

Next, at operation 758, a debt item may be selected, and the interest rate associated with that debt item may be determined. Operation 758 may include accessing a financial institution of an entity, and determining the amount and interest rate of a given loan, credit card balance, etc. The interest rate of the debt item may then be compared to the adverse and beneficial threshold values at operation 760. If the debt item interest rate is less than (and in some cases equal to) the beneficial debt interest rate threshold, as determined at operation 762, the debt item may be classified as beneficial debt at operation 764. If the debt item interest rate is not less than (and in some cases equal to) the beneficial debt interest rate threshold, then process 700b may proceed to operation 766, in which the debt item interest rate may compared to the adverse debt interest rate threshold. If the debt item interest rate is less than (and in some cases equal to) the adverse debt interest rate threshold, then the debt item may be classified as neutral debt, at operation 768. If the debt item interest rate is not less than (and in some cases equal to) the adverse debt interest rate threshold, then the debt item may be classified as adverse debt, at operation 770.

In some alternative cases, only one threshold may be used, such that a debt item is classified as either beneficial debt if it has an interest rate that is less than the threshold interest rate, or adverse debt if it has an interest rate that is greater than the threshold interest rate. In this example, the threshold interest rate may be determined based on a benchmark interest rate, as described above in reference to the beneficial and adverse interest rate thresholds. In some cases, process 700b may be performed for each debt item associated with a consumer.

Returning to FIG. 7A, as the example flow chart indicates, process 700a may include downloading or obtaining the consumer's gross/net income, beneficial debt, and adverse debt at operations 702, 706, and 710. Various embodiments can calculate the consumer's debt portfolio ratio on a monthly basis, which in some examples means the consumer's monthly gross/net income 704 and monthly beneficial 708 and adverse 712 debt obligations may be downloaded, obtained and/or determined monthly, but the schedule can be any schedule that makes sense (e.g., daily, weekly, monthly, quarterly, etc.). When it comes to the beneficial and adverse debt amounts 708, 710 to be used in these calculations, some embodiments can use the minimum payments (e.g., the minimum mortgage payment, the minimum credit card payment(s), etc.) but various embodiments encompass and allow for using any amount. If, for example, the consumer adds an additional (principal) payment to their mortgage, the larger payment may be used as the amount of their (normally beneficial) debt; or if the consumer pays off their credit card(s) every month the amount of (normally adverse) debt could be zero for that/those credit cards. It can be desirable in various examples for such values to be downloaded directly from the consumer's own financial sources in order to minimize any potential errors, because downloading from a third-party data source can be fraught with inaccuracies as highlighted by the credit data from the credit bureaus.

In some aspects, if the consumer has no beneficial debt (e.g., beneficial debt obligations is zero), as determined at operation 714, the consumer's debt portfolio ratio, in some examples, can be calculated as the ratio between the consumer's adverse debt (obligations) versus (gross/net) income, at operation 716. If the consumer does have beneficial debt (e.g., beneficial debt obligations are greater than zero), as determined at operation 714, the consumer's debt portfolio ratio can be calculated as the ratio between the consumer's adverse debt (obligations) versus beneficial debt (obligations), at operation 718. Please note that various embodiments encompass and allow for calculating the debt portfolio ratio as the ratio between the consumer's adverse debt (obligations) versus (gross/net) income even if the consumer does have beneficial debt. Once the debt portfolio ratio has been determined at either operation 716 or 718, the consumer's debt portfolio factor may be determined at operation 720, and stored (e.g., along with the gross/net income, beneficial debt obligations, and adverse debt obligations) in a safe and secure location so it can be used to show the consumer's historical financial health, at operation 722.

For the data used in this calculation, the gross/net income 704 can contain all active and passive income streams (e.g., salary, rental income, commissions, bonuses, alimony/palimony income, social security income, retirement income, etc.). Items like dividends, investment income, and annuities can also be part of the consumer's gross/net income. Likewise, the beneficial/adverse debt obligation values 708, 712 can be the combination of a consumer's debt payments; this can contain items like mortgage payments, home equity line of credit (HELOC) payments, child support payments, alimony/palimony payments, credit card payments, and loan payments (whether the loan is tied to an asset or not).

In order to calculate the consumer's debt portfolio factor at operation 720, some embodiments can determine how well the consumer is doing with regards to their debt portfolio ratio. To do this, in various embodiments we can find one or more ideal or benchmark debt portfolio ratios based on sound financial principles. As an example, consider the example 28/36 rule discussed under debt-to-income factor. It generally says that a consumer's total debt should be no more than 36% of their income and that housing debt should be no more than 28% of income. In some examples, housing debt is considered beneficial debt so it can be defined that adverse debt should be no more than 8% of income (36% minus 28%). For the consumer to be financially healthy, adverse debt in some examples should be less than 8% (the consumer might have neutral debt as well), somewhere between 0% and 5% (of income).

As already indicated, another way to look at this is, in some examples, can be to compare adverse debt versus beneficial debt. In such an example, the debt portfolio ratio should therefore be between 0% and 18% (5/28, or 17.86%) of beneficial debt. In some examples, a consumer might not have beneficial debt and, if so, various embodiments can measure the debt portfolio ratio as adverse debt versus the consumer's (gross/net) income. In such an example, the debt portfolio ratio should therefore be between 0% and 5% of (gross/net) income. When it comes to the perfect debt portfolio ratio, it can be 0% in some examples, but further examples can allow “some” adverse debt. Therefore, the ideal debt portfolio ratio can be between 0% and 2% in some examples.

Various embodiments can determine if there is an upper limit for the debt portfolio ratio. Using the same “28/36 rule” example as above, we see that the maximum debt portfolio ratio in such an example can be around 18% if the consumer has beneficial debt (e.g., adverse debt should be around 18% of beneficial debt). Again, allowing for some variation, the maximum debt portfolio ratio can be between 16% and 20% if the consumer has beneficial debt (e.g., adverse debt should be between 16% and 20% of beneficial debt). If the consumer does not have beneficial debt, using the same 28/36 example as above, the maximum debt portfolio ratio can be around 5% of the consumer's (gross/net) income. Allowing for some variation, the maximum debt portfolio ratio can then be somewhere between 3.5% and 6.5% of the consumer's (gross/net) income. If the consumer's debt portfolio ratio is equal to the maximum allowed debt portfolio ratio—or higher, the consumer can get a zero score for their debt portfolio factor in some embodiments.

Various embodiments can consider if the debt portfolio factor should be linear between these end points (e.g., the ideal ratio and the maximum allowed ratio), or if some other type of mathematical equation should be used to determine the debt portfolio factor. There are many types of equations that would make sense in this scenario to (e.g., linear, quadratic, hyperbolic, logarithmic, etc.), such that various examples encompass and allow for the use of any suitable mathematical equation to determine the debt portfolio factor.

In some embodiments, if the consumer's debt portfolio ratio is at, or below, the ideal ratio, the consumer's debt portfolio factor can be 100% (e.g., a perfect score). In some examples, if the consumer's debt portfolio ratio is at, or above, the maximum allowed ratio, the consumer's debt portfolio factor can be 0%. In some examples, it can be desirable to divide up the debt portfolio factor into separate bands or ranges and not use one band between 0% and 100%. Various embodiments encompass and allow for dividing up the scale between 0% and 100% debt portfolio factor into any suitable number of bands and using any suitable type of mathematical equation in each band.

In one example where a consumer has beneficial debt, the ideal debt portfolio ratio may be selected as 1% (i.e., adverse debt is 1% of beneficial debt) and the maximum allowed debt portfolio ratio is 18%; (i.e., adverse debt is 18% of beneficial debt) that means the consumer's debt portfolio factor will be 100% if their debt portfolio ratio is 1% or lower, and 0% if their Debt Portfolio ratio is 18% or higher. The score can be divided between 1% (debt portfolio ratio) and 18% (debt portfolio ratio) into three example bands as follows:
If the debt portfolio ratio is greater than or equal to 1(%) and less than 10(%), then the debt portfolio factor will go from 100% (if the debt portfolio ratio is equal to 1) to 70%
If the debt portfolio ratio is greater than or equal to 10(%) and less than 12(%), then the debt portfolio factor will go from 70% (if the debt portfolio ratio is equal to 10) to 30%
if the debt portfolio ratio is greater than or equal to 12(%) and less than 18(%), then the debt portfolio factor will go from 30% (if the debt portfolio ratio is equal to 12) to 0%
   As already stated, if the debt portfolio ratio is less than 1%, the debt portfolio factor would be 100% and if the debt portfolio ratio is greater than 18%, the debt portfolio factor would be 0%. Continuing on the example, the following may be selected for the formulas for creating the debt portfolio factor:
If the debt portfolio ratio is greater than or equal to 1(%) and less than 10(%), then use a logarithmic formula to calculate the debt portfolio factor
if the debt portfolio ratio is greater than or equal to 10(%) and less than 12(%), then use a linear formula to calculate the debt portfolio factor
if the debt portfolio ratio is greater than or equal to 12(%) and less than 18(%), then use a cubic formula to calculate the debt portfolio factor

Since various embodiments allow for the maximal flexibility, it can be desirable in some examples to select the most appropriate bands and formula for each band to make sure to measure the true financial health of the consumer. In some examples, a simple linear formula may be used, with the following values:
Healthiest ratio=the Debt Portfolio ratio that will give the highest Debt Portfolio factor in the band
Unhealthiest ratio=the Debt Portfolio ratio that will give the lowest Debt Portfolio factor in the band
Max score=the maximum Debt Portfolio factor in the band
Min score=the minimum Debt Portfolio factor in the band
Score range=Max score−Min score
Value=the consumer's Debt Portfolio ratio (must, of course, be within the band)
Step=1/ABS(Healthiest ratio—Unhealthiest ratio), where ABS(x) is the absolute value of x
Relative ratio=AB S(Healthiest ratio−Value)
   To calculate the consumer's debt portfolio factor, the following formula may be used:

Debt Portfolio factor=Max score−(Relative ratio*Step*Score range)

If the consumer has a debt portfolio ratio of 11% and using the example above, the following values may be determined:
Healthiest ratio=10
Unhealthiest ratio=12
Max score=70
Min score=30
Score range=70−30=40
Value=11
Step=1/ABS(10−12)=1/2=0.5
Relative ratio=ABS(10−11)=1
Debt Portfolio factor=70−(1*0.5*40)=70−20=50, i.e., 50%

In other examples, one or more other formulas may be used (e.g., a hyperbolic formula, quadratic, logarithmic, etc.). As discussed herein, these are merely examples in accordance with some embodiments, so these example embodiments should not be construed to be limiting.

FIG. 8 illustrates another example process for determining a debt factor, such as may be performed by the evaluation system 100 described above in reference to FIG. 1 and/or used in the financial evaluation process 200 described above in reference to FIG. 2. In some cases, process 800 may be performed by or may be a specific example of the debt portfolio/debt factor processes 126 described above in reference to FIG. 1. In some cases, as used herein a debt portfolio factor may refer to the factor calculated via process 700a described above in reference to FIG. 7A. In some cases, an alternative to the debt portfolio factor may the debt factor, which can be calculated via process 800 described below.

Another alternative to the debt portfolio factor is the debt factor, which considers the amount of debt payment of adverse debt relative to the total outstanding adverse debt. This debt factor focuses on the adverse debt as this is a source of continued problems for consumers. The typical example of adverse debt is credit cards. Since the interest rate of credit cards are typically much higher than most other debt vehicles, if the consumer does not pay off their credit cards every month it can quickly become very difficult to get out of credit card debt. Therefore, in order to determine a consumer's financial health, it is important to consider how much of the consumer's adverse debt they pay every month.

To measure the health of a consumer's handling of their adverse debt, the amount of adverse debt payment(s) relative to the total amount of adverse debt may be measured, such as via process 800 described below. As the flow chart indicates, consumer's adverse debt payment(s) and total outstanding adverse debt may be obtained/determined at operations 802 and 806. In some cases, process 700b of FIG. 7B may be performed in addition to process 800 described herein, such that operation 802 of process 800 may take as an input, a sum of all the debt items identified as adverse debt by process 700b.

In some cases, the debt ratio may be calculated on a monthly basis, which means the consumer's monthly adverse debt payment(s) 804 and total outstanding adverse debt obligations 808 would be obtained every month, but the schedule can be any schedule that makes sense (e.g., daily, weekly, monthly, quarterly, etc.). In some aspects, these values may be downloaded directly from the consumer's own financial sources in order to minimize any potential errors, as downloading from a third-party data source can be fraught with inaccuracies as highlighted by the credit data from the credit bureaus. If the consumer has no adverse debt (i.e., adverse debt obligations is zero), as determined at operation 810, then the consumer's debt ratio may be set to 1 (a perfect score) at operation 812. If the consumer does have adverse debt (i.e., adverse debt obligations are greater than zero), as determined at operation 810, then the consumer's debt ratio can be calculated as the ratio between the consumer's adverse debt payment(s) versus the consumer's total outstanding adverse debt obligations, at operation 814. Once the debt ratio has been determined, the consumer's debt factor can be determined at operation 816, and the debt factor (along with the total adverse debt obligations and adverse debt payment(s)) may be stored in a safe and secure location so it can be used to show the consumer's historical financial health, at operation 818.

For the data used in this calculation, the adverse debt payment(s) portions may be the combination of a consumer's (adverse) debt payments, such as including items such as credit card payments, and loan payments (whether the loan is tied to an asset or not). The total outstanding debt obligations would then be the combination of all of the consumer's adverse debt obligations.

In order to calculate the consumer's debt factor, how well the consumer is doing with regards to their debt ratio may be determined. To do this, one or more ideal or benchmark debt ratio values may be used, based on sound financial principles. When it comes to adverse debt, this is very easy and straightforward. To be completely financially healthy, the consumer should always pay off their entire adverse debt obligations every month—and thereby avoid paying any excessive interest rates. In other words, the debt ratio should be 1. Likewise, the worst a consumer can do is to not pay off any of the adverse debt in a month or (slightly better) only pay the minimum (adverse) debt payment for the month. As an example, many credit card companies set the minimum debt payment in a month to be around 2% of the total outstanding credit card debt. Using this example, the minimum allowed debt ratio could be between 0% and 2% or 3%. If the consumer's debt ratio is equal to the minimum allowed debt ratio (or lower), the consumer should get a zero score for their debt factor.

In some cases, it should be considered if the debt factor should be linear between these end points (i.e., the ideal ratio and the minimum allowed ratio), or if some other type of mathematical equation can be used to determine the debt factor. There are many types of equations that would make sense in this scenario (e.g., linear, quadratic, hyperbolic, logarithmic, etc.), that could be used to determine one or more bands within the debt factor score.

Based on the above, if the consumer's debt ratio is at the ideal ratio, the consumer's Debt factor should be 100% (i.e., a perfect score). If the consumer's debt ratio is at, or below, the minimum allowed ratio, the consumer's debt factor should be 0%. Sometimes, it may be beneficial to divide up the debt factor into separate bands or ranges and not use one band between 0% and 100%. The described techniques encompass and allow for dividing up the scale between 0% and 100% (debt factor) into any number of bands and using any type of mathematical equation in each band.

In one example, the ideal debt ratio may be 100% (i.e., adverse deb payment is equal to total outstanding adverse debt) and the minimum allowed debt ratio may be 0%; (i.e., adverse debt payment is 0% of total outstanding adverse debt), which means the consumer's debt factor will be 100% if their debt ratio is equal to 100% (or higher), and 0% if their debt ratio is 0% or lower. The score may be divided between 100% (debt ratio) and 0% (debt ratio) into three bands as follows:
If the debt ratio is greater than or equal to 0(%) and less than 20(%), then the debt factor will go from 0% (if the debt ratio is equal to 1%) to 60%
If the debt ratio is greater than or equal to 20(%) and less than 80(%), then the debt factor will go from 60% (if the debt ratio is equal to 20%) to 80%
If the debt ratio is greater than or equal to 80(%) and less than or equal to 100(%), then the debt factor will go from 80% (if the debt ratio is equal to 80%) to 100%

As already stated, if the debt ratio is less than 0% the debt factor would be 0% and if the debt ratio is equal to or greater than 100%, the debt factor would be 1. Continuing on the example, the formulas may be used to create the debt factor:
If the debt ratio is greater than or equal to 0(%) and less than 20(%), then use a linear formula to calculate the debt factor
If the debt ratio is greater than or equal to 20(%) and less than 80(%), then use a hyperbolic formula to calculate the debt factor
If the debt ratio is greater than or equal to 80(%) and less than or equal to 100(%), then use a cubic formula to calculate the debt factor

Since the described techniques allow for the maximal flexibility, it is important to select the most appropriate bands and formula for each band to make sure to measure the true financial health of the consumer. A general example may be illustrated, using the following values:
Healthiest ratio=the Debt ratio that will give the highest Debt factor in the band
Unhealthiest ratio=the Debt ratio that will give the lowest Debt factor in the band
Max score=the maximum Debt factor in the band
Min score=the minimum Debt factor in the band
Score range=Max score−Min score
Value=the consumer's Debt ratio (must, of course, be within the band)
Step=1/ABS(Healthiest ratio−Unhealthiest ratio), where ABS(x) is the absolute value of x
Relative ratio=AB S(Healthiest ratio−Value)

To calculate the consumer's Debt factor, the following formula may be used:

Debt factor=Max score−(Relative ratio*Step*Score range)

If the consumer has a Debt ratio of 10% and using the example above, the following values may be determined:
Healthiest ratio=20
Unhealthiest ratio=0
Max score=60
Min score=0
Score range=60−0=60
Value=10
Step=1/ABS(20−0)=1/20=0.05
Relative ratio=ABS(20−10)=10
Debt factor=60−(10*0.05*60)=60−30=30, i.e., 30%

In other examples, one or more other formulas may be used (e.g., a hyperbolic formula, quadratic, logarithmic, etc.). As discussed herein, these are merely examples in accordance with some embodiments, so these example embodiments should not be construed to be limiting. In some examples, both the debt factor and the debt portfolio factor may be used to determine an FHS. In some cases, the scores may be separately used, or in some cases combined (such as an average or weighted sum, for example), to produce a combined debt/debt portfolio factor.

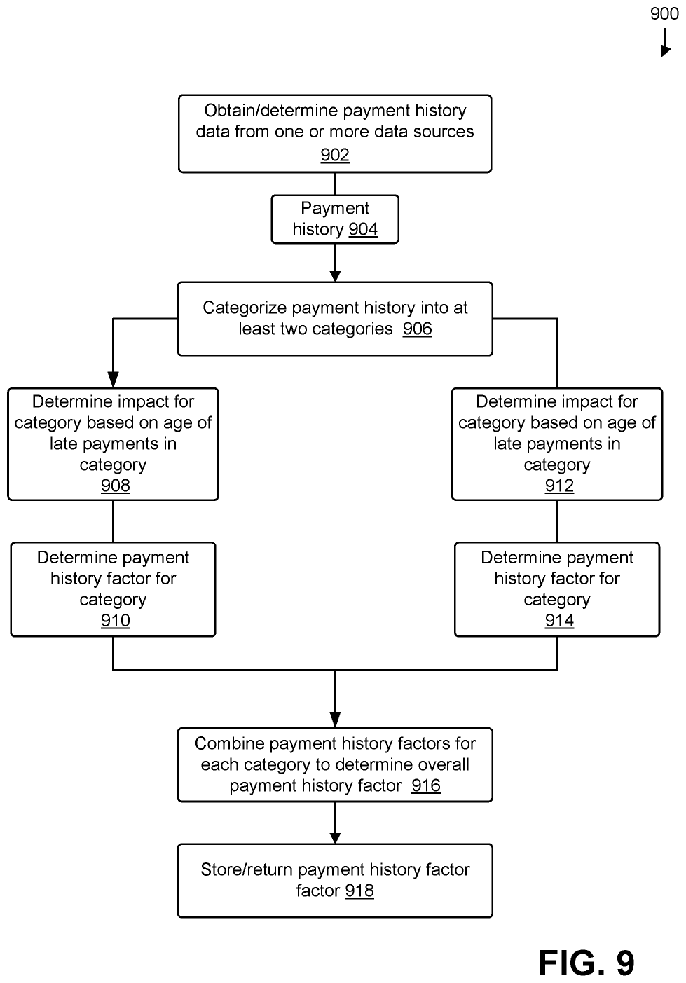

FIG. 9 illustrates an example process for determining payment history factor, such as may be performed by the evaluation system 100 described above in reference to FIG. 1 and/or used in the financial evaluation process 200 described above in reference to FIG. 2. In some cases, process 900 may be performed by or may be a specific example of the payment history factor process 122 described above in reference to FIG. 1.

To determine how financially healthy a consumer is, it can be desirable in some embodiments to understand how well the consumer handles their bills/invoices—e.g., whether the consumer pays their bills on time. A consumer's payment history can be found in their financial transactions, but whether or not a bill is paid on time may also require knowing the due date of the bill. Various embodiments can consider that presently, some institutions report a late payment and some do not (and the threshold for whether a payment is considered late can differ based on the institution). One example of criteria for whether a payment should be considered late, is if the institution reports the late payment to a credit bureau (or several credit bureaus). In various embodiments, the consumer's payment transactions can be used directly to determine whether a payment is late, for example when some type of indication that the payment is late is available with the transaction (such as in an end of the month billing statement, for example). In some cases, although credit data from credit bureaus have been shown to be fraught with inaccuracies in some embodiments, the best source of payment history, may in some cases, be from the credit bureaus.

As the example flow chart indicates, process 900 may include downloading or otherwise obtaining the consumer's payment history, at operation 902, in order to identify the consumer's late payments, and the age of each of those late payments. Notice that not all bills are equal in some embodiments, e.g., being late on the internet bill could lead to loss of access to the internet while being late on the mortgage could (eventually) lead to the loss of the home. One novel approach of various embodiments includes divide the late payments into one or several categories, such as at operation 906 where the categories can reflect the importance of the different categories. As an example, the late payments 904 may be divided into three categories: mortgages, other loans/debts, and bills other than loans (e.g., utilities, phones, internet, etc.), where mortgages may carry the most importance and bills (other than loans) less importance. In other cases, the payments may be divided into two categories, one of importance and one of less importance, as illustrated in FIG. 9. Once the data has been categorized, an impact value for each category can be determined, at operations 908 and 912, such as based on the history of the late payments in each category (as will be described in greater detail below). The consumer's payment history factor for each category may then be determined at operations 910 and 914. The individual category payment history factors may then be combined, at operation 916, into an overall payment history factor, such as using an average or weighted sum. The payment history factor (along with the payment history) may then be stored in a safe and secure location so it can be used to show the consumer's historical financial health, at operation 918. Some embodiments can calculate the consumer's payment history factor monthly, but the schedule can be any schedule that makes sense (e.g., daily, weekly, monthly, quarterly, etc.).

In yet other cases, only one category of payments or types of payments may be used, such that process 900 may proceed from operation 902 directly to operations 908, 910 and then to operation 918, where there is no categorization step. This implementation may be utilized in various scenarios, including to reduce computational complexity of determining the payment history factor, in cases where the consumer may not have more than one categorization of late payments, or for various other reasons. In this example, each late payment may be modified by a factor based on an age of the late payment, where the modified late payment values may then be combined, as described in greater detail below.

Although various embodiments encompass and allow for considering any number of years of payment history, the payment history factor may only consider the last two years in some examples. For most credit scores and credit reports, a late payment will remain on their records for seven years which means it will take a consumer an inordinate amount of time to improve this aspect of their finances. Also, unlike some credit scores, the financial health score in various embodiments can retain a historical record of all factors which can allow a lender to view a consumer's historical payment history if needed. Restricting the payment history to two years in some examples can mean that the consumer can quickly improve their payment history factor (by avoiding any more late payments) which can act as a big incentive to the consumer to keep a perfect payment history or improve their payment history.

When determining the payment history factor, some embodiments can determine how well the consumer is doing relative to one or more ideal or benchmark payment history values. In some examples, the ideal number of late payments can be zero, but further examples can allow some late payments. Since various embodiments can allow for categorizing the late payments, 2 or 3 late payments in a less important category may be allowed, for the consumer still to get a perfect payment history factor in that category (i.e., even with 2 or 3 late payments).

Various embodiments can determine if there is an upper limit for the payment history factor, e.g., the number of late payments at which the payment history factor becomes zero. Since various examples encompass and allow for having several different categories of late payments, the maximum number of late payments can differ from category to category. For the category/categories considered most important, some embodiments can allow 2 to 5 late payments while for a less important category, can allow 4 to 9 late payments.

Various embodiments can consider if the payment history factor should be linear between these end points (i.e., the ideal number of late payments and the maximum number of late payments) or if some other type of mathematical equation may be used to determine the payment history factor. There are many types of equations that would make sense in this scenario (e.g., linear, cubic, hyperbolic, logarithmic, etc.); various examples encompass and allow for the use of any suitable mathematical equation to determine the payment history factor.

In various embodiments, if the consumer's number of late payments is at, or below (if feasible), the ideal number, the consumer's payment history factor can be 100% (e.g., a perfect score). If the consumer's number of late payments is at, or above, the maximum number of late payments, the consumer's payment history factor can be 0%. In some examples, it can be desirable to divide up the payment history factor into separate bands or ranges and not use just one band between 100% and 0%. Various embodiments encompass and allow for dividing up the scale between 0% and 100% (Payment History factor) into any suitable number of bands and using any suitable type of mathematical equation in each band—for each category of late payments.

Some embodiments may only consider if a consumer has a late payment or not, and not consider the age of the late payment(s). However, this may be undesirable in some examples because this may mean that any late payments can negatively affect the consumer's credit score for the entire two years (or even longer or less in some cases), and with the same impact throughout the entire time. Instead of such a binary impact, a novel approach of various embodiments includes taking into consideration the age and not just the occurrence of late payments: for example, the older the late payment is, the less it should count against the payment history factor. This can mean a consumer that starts taking their payment history seriously can positively influence their financial health score immediately by avoiding any additional late payments. Some embodiments can therefore apply a greater weight to more recent late payments and less weight to older late payments; which means a late payment can gradually count less and less the older it gets (and disappear when it is more than 2 years old in various examples). Some embodiments can consider if the age of the late payment impact should be linear, such as between 0 months and 24 months, or if some other type of mathematical equation may be used to determine the impact. There are many types of equations that would make sense in this scenario (e.g., linear, quadratic, cubic, etc.); various examples encompass and allow for the use of any suitable mathematical equation to determine the impact of the age of the late payments.

Various embodiments can allow for different ways of considering the age of the late payments. For example, some embodiments can consider each late payment and combine it with the age of the late payment, determine the average age of the late payments and combine that with the number of late payments, determine the most recent late payment and combine that with the number of late payments, or any other suitable type of combination. Various other options are within the scope of the present disclosure.

To calculate the impact of each of the late payments in each of the late payment categories, in some embodiments, the number of late payments may be combined with the age of the late payments. The combination in some examples can be as simple as a multiplication between the two or can be any suitable complex mathematical formula that can reflect the health of the consumer with respect to the payment history factor; various embodiments encompass and allow for the use of any suitable mathematical equation to combine the two (i.e., late payment and the age of late payment).

Additionally, if there are more than one category of late payments (see above), some embodiments can combine the categories to determine the consumer's overall payment history factor. The combination can be any mathematical combination that makes sense, e.g., use the maximum/minimum category payment history factor, use the average of the categories' payment history factors, use a weighted average of the categories' payment history factors, etc. Various embodiments encompass and allow for the use of any such mathematical combination.

As an example, one way to do this is to use different weights for each category that reflects the category's relative importance (or use the same weight for each category if the (relative) importance of each category is the same), when calculating the overall payment history factor. In the previous example, most weight may be placed on the mortgage category, less on the other loans/debt category, and least on the bills (other than loans) category (e.g., 60% on mortgage category, 30% on other loans/debt category, and 10% on bills (other than loans) category). Once the weighting of the (late payment) categories has been determined, the categories may be combined by any mathematical formula, where various embodiments encompass and allow for the use of any suitable mathematical equation. The combining process may be as simple as an addition or any complex formula that correctly reflects the consumer's financial health with respect to the payment history factor.

This may be highlighted using the example below, where two categories are used for the late payments: mortgage and other. The consumer has the following late payments: Late mortgage payment, 3 months ago, Late credit card payment, 6 months ago, Late mortgage payment, 15 months ago.

For the categories, the following may be used:

Mortgage category (most recent 24 months, linear formula, 60% weight)
Ideal number of late payments: 0
Maximum number of late payments: 3
One band from 0% to 100%, linear formula
Only considering the age of the most recent late payment
   Other category (most recent 24 months, linear formula, 40% weight):
Ideal number of late payments: 0
Maximum number of late payments: 5
One band from 0% to 100%, linear formula
Considering the age of all late payments

For simplicity, both categories can use a linear formula. First, some example values may be defined as follows:
Healthiest number=the number of late payments that will give the highest Payment History factor in the band
Unhealthiest number=the number of late payments that will give the lowest Payment History factor in the band
Max score=the maximum Payment History factor in the band
Min score=the minimum Payment History factor in the band
Score range=Max score−Min score
Value=the consumer's number of late payments (must, of course, be within the band)
Step=1/ABS(Healthiest number—Unhealthiest number), where ABS(x) is the absolute value of x
Relative number=ABS(Healthiest number−Value

To calculate the consumer's interim payment history factor, the following formula may be used:

Interim Payment History factor=Max score−(Relative number*Step*Score range)

Using the example above, the following two interim payment history factors may be determined:

### Mortgage Category

Healthiest number=0
Unhealthiest number=3
Max score=100
Min score=0
Score range=100−0=100
Value=2
Step=1/ABS(3−0)=1/3
Relative number=ABS(0−2)=2
Interim Payment History factor=100−(2*1/3*100)=100−66.67=33.33, i.e., 33.33%

### Other Category

Healthiest number=0
Unhealthiest number=5
Max score=100
Min score=0
Score range=100−0=100
Value=1
Step=1/ABS(0−5)=1/5=0.2
Relative number=ABS(0−1)=1
Interim Payment History factor=100−(1*0.2*100)=100−20=80, i.e., 80%

Some embodiments can consider the age of the late payments and can combine the two interim payment history factors to produce the resulting overall payment history factor. For the mortgage category, in some examples only the age of the most current late payment may be considered, which is 3 months in this example. For the “other” category, the age of all the late payments may be considered, but since there is only one late payment in this category in this example the age is 6 months.

For simplicity, some examples can use a linear formula to determine the impact of the late payments. One way is to make the step be 1/24 since the age of the late payments will be between 1 and 24 months (or other selected time period). Since in various examples, the highest impact should occur for the lowest number (i.e., the more recent the late payment is, the higher the impact), the impact can go from 1 (or 24/24, for 1 months old late payment) to the minimum (or 1/24, for 24 months old late payment). The following formula may be used:

Impact=1−(Age of late payment−1)*Step

Using this formula, the following impact numbers may be determined:

Mortgage category: Impact=1−(3−1)*1/24=1−2/24=0.9167

Other category: Impact=1−(6−1)*1/24=1−5/24=0.79167

The final interim payment history factor for each of the two categories may then be determined as:

Mortgage category: Interim Payment History factor=33.33%*0.9167=30.55%

Other category: Interim Payment History factor=80%*0.79167=63.33%

Additionally, in some cases, a simple weighted sum may be used to calculate the overall payment history factor:

Payment History factor=Sum of (Category weight*Interim Payment History factor)

For the above example, the following may be calculated:

Payment History factor=(60%*30.55)+(40%*63.33)=18.33+25.33=43.66, i.e., 43.66%

In other examples, one or more other formulas may be used (e.g., a hyperbolic formula, quadratic, logarithmic, etc.). As discussed herein, these are merely examples in accordance with some embodiments, so these example embodiments should not be construed to be limiting.

FIG. 10 illustrates another example process 1000 for generating a financial evaluation or financial health score, which may be performed by the evaluation system 100 described above in reference to FIG. 1. In some cases, process 1000 may incorporate one or more aspects of processes 200-900 described above in reference to FIGS. 2-9.

As illustrated, process 1000 may begin at operation 1002, in which financial data relating to an entity or consumer may be obtained. In some cases, the financial data may include all or a portion of a consumer or entity's complete financial picture, including bank accounts, credit cards, loans and other debt, various bills, and so on, as described above. In some cases, the data may be obtained directly from the banking or financial institution providing the financial instrument, for example, to ensure better accuracy of the data obtained. The financial data may then be classified or categorized into one of a number of different factors, at operation 1004. In some cases, operation 1004 may include one or more aspects of process 1100a described below in reference to FIG. 11A, utilizing the data categories 1100b described in reference to FIG. 11B.

In some cases, a factor to determine may be selected, at 1006, such as one or both of the debt portfolio factor and/or the debt factor, and/or one or more of the debt-to income factor, the total spending factor, the saving factor, the liquid reserves factor, or the payment history factor. Next, it may be determined if the selected factor is associated with multiple bands or ranges of determining the factor, such as described above in greater detail, at operation 1008. In some cases, this may include any of the debt portfolio factor, the debt factor, the debt-to income factor, the total spending factor, the saving factor, the payment history factor, or the liquid reserves factor. If the determination is negative, the selected factor may be determined at operation 1018, such as according to the applicable process described above. If the determination is positive, then the ratio associated with the selected factor may be determined at operation 1010, such as according to the applicable processes 300-800 described above.

Next, at operation 1012, the factor score may be determined, such as using at least two different equations for the two different bands or ranges of values. In some cases, for a given factor, scores for that factor may be broken into two or any number of bands or ranges, such as using one or more threshold values. In some cases, each band or range of factor scores may correlate to a range of values for the ratio determined for that specific factor. In these instances, process 1000/operation 1012 may include separating the score values into two or more ranges of values, such as by determining one or more threshold values that define the boundaries of the two or more ranges or bands. In some cases, a different equation or relationship may be associated to each distinct band or range of values, such that defines the relationship between converting a ratio value for a given factor to a factor score. The ratio for a given factor may then be converted to a factor score using the appropriate equation or relationship based on the value of the ratio value.

Process 1000 may then proceed to operation 1014, either after operation 1012 or operation 1018, where it may be determined if there are other factors to determine. In some cases, the financial score or evaluation may be determined based on any number of the 6 factors described above. If yes, process 1000 may loop back to operations 1008, and continue to loop through operations 1008, 1010, 1012, 1014, or 1008, 1018, 1014 as applicable. When there are no more factors to determine, the calculated factor scores may be combined to generate a FHS or evaluation, at operation 1016, such as via any of a number of different combination techniques.

### Data Categorization

Presently, there are many financial institutions that categorize a consumer's financial transactions (i.e., transactions within that financial institution). There are also software companies that deliver APIs (Application Programming Interfaces) for accessing financial institutions' transactions that categorize a consumer's financial transactions. The way these categorizations are normally done is to categorize a transaction into one of (sometimes very) many spending categories (e.g., Food and Drink, Healthcare, Recreation, etc.) and there can also be sub (and sub-sub) categories (e.g., Healthcare->Physicians->Urologists, etc.). Although this is done with the best intentions in mind (e.g., so a consumer can understand in which categories they are spending the most money), the sheer number of categories can often be confusing and lead to mis-categorization (as the number of categories increase, so does the likelihood of categorizing a transaction incorrectly), and—more importantly—it does not necessarily make the consumer better understand their financial health.

For a consumer to better understand their financial health, it can be important in some examples to take a holistic view of the consumer's finances and hence incorporate all the consumer's financial data sources. The financial information from these data sources should be divided into categories that highlight the different aspects of the consumer's financial health. Unfortunately, no such categorization exists today. In light of the foregoing, a need exists for an improved system and method for categorizing a consumer's financial data.

To understand the financial health of a consumer, in various embodiments it can be desirable to understand all aspects of their finances. Debt analysis and payment history, which are often the only aspects considered in a credit score, can be important, but in various examples, without a cash flow analysis there is no way to correctly determine a consumer's real financial health. Accordingly, in some embodiments it can be desirable to create a balance sheet for the consumer that includes things like the consumer's assets.

Various embodiments can consider some or all of a consumer's relevant financial data sources and transactions and can categorize the data/transactions into a set (e.g., small) number of (e.g., financial) categories.

FIG. 11A illustrates an example process 1100a for categorizing input data, which may be performed or used by the data classification system 142 of evaluation system 100 described above in reference to FIG. 1.

Process 1100a may begin at operation 1102, in which one or multiple financial institutions, such as banks, mortgage companies, lenders, utility providers, etc., may be identified for an entity or individual. A first financial institution of the identified financial institution(s) may be selected and accessed, such as via a website provided by the institution accessed via credentials provided by the entity or individual, at operation 1104. All accounts associated with the entity held or controlled by the financial institution may then be identified at operation 1106. A first account of the identified accounts may then be selected and accessed, at operation 1108, such as using credentials provided by the entity or individual. Next, a transaction for the selected account may be selected for a given time period (such as 2 years to capture payment history, or any time periods, such as monthly, to capture financial data used to generate or update a financial health score with respect to another one of the factors described above), at operation 1110.

At operation 1112, the transaction, including amount, date, and in some aspects, other information, may be categorized into one or a plurality of different financial data categories, such as may be used by the evaluation service 102 and/or components thereof to generate or update a financial health evaluation score. In some aspects, operation 1112 may utilize the data category scheme or data structure 1100b described below in reference to FIG. 11B, and/or be based on individual characteristics of the transaction, as described in greater detail below. Next at operation 1114, it may be determined if there are more transactions for the selected account in the time period. If there are more transactions, process 1100a may loop back to operation 1110 through operation 1114 until all the transactions for an account have been categorized for the given time period. Once all transactions have been categorized for a given account, it may be determined if another account is associated with the entity for the selected financial institution, at operation 1116. If so, then another account may be selected at operation 1118, and process 1100a may loop back through operations 1110 to operation 1116, until no more accounts can be identified for the entity with the selected financial institution. If there are more financial institutions associated with the entity, as determined at operation 1120, another financial institution may be selected at operation 1122, and process 1100a may loop back through operations 1106-1120, until no more financial institutions for the entity are identified, at which point, categorization process 1100a may end at operation 1124.

In some cases, an entire account may be categorized, rather than or in addition to individual transactions, as described above in process 1100a. In some examples, the balance of an account may be useful to determine a financial health score for an entity. For example, an account may be identified as a savings account, a retirement, a debt account, etc., or other account in which a balance value may be needed or useful. In these cases, the account balance may be obtained, and classified into one of a number of different categories to be sued to determine one or more financial factors, as described herein.

The present disclosure describes examples of which type of data belong in each category to make it straightforward to create an automatic categorization method in accordance with various embodiments. FIG. 11B illustrates an example diagram 1100b of categories used to classify financial data, such as to aid in generating a financial health score for a consumer or entity. The data categories in some examples can comprise one or more of the following, which will be described in greater detail below:
Gross income 1152
Net income 1154
Debt obligations 1156, which can be further divided into:
   Beneficial debt 1166
   Neutral debt 1168
   Adverse debt 1170
Savings amount 1158
Total expenses 1160
Liquid reserves 1162
Late payments 1164 (number and age), potentially divided into:
   Mortgages 1172
   Other loans/debt 1174
   Bills (other than loans) 1176
      As illustrate, late mortgage payment category 1172, other loans/debt category 1174, and other bills category 1176 may be associated with a number of late payments 1178, 1182, 1186, and an age 1180, 1184, 1188. In other cases, late payments may be broken into two different categories, as follows:
Number of late payments, potentially divided into:
   Mortgages
   Other loans/debt
   Bills (other than loans)
Age of late payments, potentially divided into:
   Mortgages
   Other loans/debt
   Bills (other than loans)

As illustrated, financial data may be obtained, at operation 1150. In some cases, the financial data 1150 may include transactions and/or account balances. The transactions and/or account balances may be allocated to one or more of the first level categories, including gross income 1152, net income 1154, debt obligations 1156, savings amount 1158, total expenses 1160, liquid reserves 1162, and late payments 1164 (number and age). In some aspects, the debt obligations categories my further be divided into two or more categories, such as beneficial debt 1166 and adverse debt 1170, and in some cases neutral debt 1168 as well, such as by process 700b described above in reference to FIG. 7B. Similarly, the late payment information may be further divided into two or more categories, such as including mortgage late payments 1172, other loans or debt late payments 1174, and other bills late payments 1176, such as via the techniques described above with respect to process 900 of FIG. 9. Each category of data will be described in detail below.

Gross Income

Gross income can be used when considering a consumer's financial health, e.g., in a debt-to-income ratio. Gross income is the consumer's income before any taxes are withheld. Gross income can include, but is not limited to, the following: salary, rental income, commissions, bonuses, tips, alimony/palimony income, Social Security income, retirement income, dividends, investment income, and annuities. The salary for the consumer can be either as a permanent employee in a company, as a contractor to a company, or as self-employed.

Identifying a consumer's gross income can be done several different ways. For example, the consumer can identify which transactions are gross income, a historic analysis of the consumer's transactions can identify the gross income, analyzing the depositors of the consumer's transactions can enable identification of the gross income, etc. In one example, recurring deposits in a given bank account may be identified as potential gross income source. In some cases, a confidence score may be determined based on a number of factors, such as depositor, period of reoccurrence (does it match a 2 week, bi monthly, or monthly typical salary or pay check frequency), if the amount is the same each time period or there is some pattern in the amount, and so on. In cases where a confidence score is used, a flagged income source may be analyzed in light of one or more of the above factors, such that if a the confidence score is above a threshold, then the transaction may be labeled as income or gross income. In some cases, to determine gross income, rather than net income, the amount of taxes withheld will need to be determined. In some cases, this can include accessing an employee's account with an employer for a copy of the paycheck, or may be determined in a number of other different ways.

Net Income

Net income can be used when considering a consumer's financial health, e.g., when considering the consumer's net cash flow. Net income is the consumer's income after any taxes are withheld. Net income can include, but is not limited to, the following: salary, rental income, commissions, bonuses, tips, alimony/palimony income, child support income, Social Security income, retirement income, dividends, investment income, and annuities. The salary for the consumer can be either as a permanent employee in a company, as a contractor to a company, or as self-employed.

Identifying a consumer's net income can be done in several different ways. For example, the consumer can identify which transactions are net income, a historic analysis of the consumer's transactions can identify the net income, analyzing the depositors of the consumer's transactions can enable identification of the net income, etc. In one example, recurring deposits in a given bank account may be identified as potential net income source. In some cases, a confidence score may be determined based on a number of factors, such as depositor, period of reoccurrence (does it match a 2 week, bi monthly, or monthly typical salary or pay check frequency), if the amount is the same each time period or there is some pattern in the amount, and so on. In cases where a confidence score is used, a flagged income source may be analyzed in light of one or more of the above factors, such that if a the confidence score is above a threshold, then the transaction may be labeled as income or net income.

### Debt Obligations

In various embodiments, it can be desirable to know the consumer's expenses. Debt obligations/payments can be a component in this aspect although some consumers might not have any (debt obligations), and is used e.g., when considering the consumer's debt-to-income ratio or net cash flow, or debt factor or debt portfolio factor.

Debt obligations can include, but are not limited to, the following: mortgages, Home Equity Line of Credit (HELOC), loans tied to an asset, alimony/palimony payments, child support payments, loans not tied to an asset, and credit card debt. Note that for mortgages, some examples can include both property taxes and insurance payments (e.g., home owner's insurance and umbrella insurance). As part of the debt obligations, it can be desirable in some embodiments to have data such as schedule (how often is the payment due), interest rate (if applicable), outstanding balance (if applicable), principal paid (if applicable), interest paid (if applicable), and any other pertinent data.

Not all debt payments are equal in various examples, and it can be desirable in some embodiments to divide them into beneficial, neutral, and adverse debt obligations (or other suitable categories) to get a complete picture of the consumer's financial health, such as described above in reference to process 700b of FIG. 7B.

Identifying a consumer's debt obligations can be done several different ways. For example, the consumer can identify which transactions are debt obligations, a historic analysis of the consumer's transactions can identify the debt obligations, analyzing the payee of the consumer's transactions can enable identification of the debt obligations, etc. In some embodiments, lending institutions can have an API that can provide some or all the necessary debt obligation information.

### Savings Amount

To ascertain if a consumer is financially healthy or not, in some embodiments it can be desirable to understand the consumer's financial habits. Part of a (financially) healthy habit in some examples can be to consistently put money aside—in savings—for the future, it is the old adage of “pay yourself first”. Having a healthy savings habit in some examples can allow the consumer to take care of both short-term needs/goals (e.g., in case of a financial “emergency” like losing your job or pay for a medical emergency) and longer-term goals (e.g., saving for retirement). Savings can be the sum of all money a consumer sets aside in “designated” savings accounts. Such accounts include, but are not limited to, the following: bank savings accounts, 401k accounts, IRA accounts (all types of IRA accounts), and investment accounts. Such accounts can amount to both shorter term financial health (e.g., bank savings accounts) and longer-term financial health (e.g., 401k accounts).

Identifying a consumer's savings amount can be done several different ways. The consumer can identify which accounts are savings accounts, some accounts (e.g., 401k accounts) are designated “savings only” accounts (up to a certain point), a historic analysis of the consumer's transactions can identify which accounts are being used for savings, various APIs can provide information about the type of accounts being used, etc.

### Total Expenses

A consumer's total expenses in various embodiments can be all spending the consumer does (“outgoing” transactions, including debt obligations)—with one important exception in some examples: savings amount (see above). A consumer's expenses can be categorized into non-discretionary living expenses and discretionary spending. Because there are so many different definitions of non-discretionary/discretionary spending and because there are so many transactions that can be classified as either non-discretionary or discretionary (e.g., gym membership, internet access, car maintenance, etc.) various examples categorize all expenses into one category: total expenses. Being financially healthy can mean being thrifty with regards to expenses, and such a categorization can allow the consumer to make personal decisions as to which expenses they consider most important (and hence can potentially reduce the “non-essential” expenses).

Identifying a consumer's total expenses in various examples can be all spending (or “outgoing” transactions) minus the consumer's savings amount.

### Liquid Reserves

In various examples it can be beneficial to a consumer's financial health that they can weather a financial hardship without going deep into debt or, worse, having to stop paying certain bills/mortgages/loans. Financial shortcomings can occur at any point during a consumer's life; things like losing a job, an unforeseen medical expense, banking crisis (e.g., what happened in 2008/2009), pandemic (e.g., what happened in 2020/2021), or some other unexpected financial loss. In such circumstances, it can be desirable for the consumer to have money available to them to be able to pay their expenses for as long as possible. In various examples, the longer the consumer can keep paying all their expenses, the healthier the consumer should be considered.

Note that in various embodiments, liquid reserves is not equal to the amount of money the consumer has in all their savings accounts. E.g., a younger consumer may not be able to withdraw money from their 401k account without penalty, and the money in their 401k account can be meant for longer-term availability (e.g., when the consumer retires). Hence it can be desirable in some examples that the liquid reserves only include “liquid” accounts, i.e., accounts where the consumer can withdraw money without (a significant) delay and/or without a (significant) penalty.

Identifying a consumer's liquid reserves can be done several different ways. The consumer can identify which accounts are liquid accounts, some types of accounts can be considered liquid/non-liquid, various APIs can provide information about the type of accounts being used to enable a determination about which accounts are liquid, etc.

### Payment History

It can be desirable in various embodiments to understand how well the consumer handles payments as another indication of the consumer's financial health and habits. A consumer's payment history can therefore be part of determining a consumer's financial health in some examples. Such payment history can comprise of knowing how many late payments—and the age of the late payments—a consumer has had in the last two years. In some embodiments, payment history will only be determined for the prior two years (or other limited timeframe), enabling the consumer to improve their payment history over time (if they avoid any other late payments going forward).

In various examples, not all payment history is considered equal. For example, some late payments are reported to credit reporting agencies (e.g., mortgage payments, credit card payments, etc.) and some late payments are not reported to credit reporting agencies (e.g., rent, electricity, etc.—note that in some cases even such bills can be reported to credit reporting agencies). There can also be late payments that have more impact than others; e.g., if a consumer stops paying their mortgage the consumer can lose their home, whereas if the consumer stops paying their internet bill they will only lose access to the internet (until the consumer brings balance to the account). To highlight such differences, in some embodiments we can further subdivide the late payments when determining a consumer's financial health. For example, payment history can be (sub) divided into any suitable number of categories and various embodiments encompass and allow for any suitable categories. Examples of such categories can include, but is not limited to, the following: mortgages, other loans/debts, and bills (other than loans).

Identifying a consumer's payment history (e.g., number of late payments and the age of each late payment) can depend on which payments are considered. Various embodiments encompass and allow for considering every payment (or at least some payments) as part of the payment history. To do this, in various examples it can be desirable to know the “pay by” date of each and every payment and potentially by which date the payee considers the payment late. Checking the pay by date (or the date by which the payee considers the payment late) against the date on which the consumer made the payment can then give us the payment history. If, on the other hand, we only consider payments that are reported to credit reporting agencies, identifying the consumer's payment history in some examples can then be found from the consumer's credit report (e.g., as an alternative to or in addition to tracking the “pay by”/late date).

### Financial Health Score Simulator

A financial health score (FHS) of various embodiments is presently the only way to accurately and objectively measure how financially healthy a consumer is. Unfortunately, many people confuse a credit score with the financial health of a consumer, but that has been clearly shown not to be the case in various examples (e.g., the data used to create a credit score does not contain items like income, spending, liquid reserves, etc.). To fully understand a consumer's financial health, it can be desirable in various examples for both the consumer and potential lenders to understand how changes in the consumer's financial data will impact their financial health.

Presently, there is no easy way for a consumer (or lender) to fully understand how changes in their financial data will impact their credit score (which is the most widely used financial score). There are many drawbacks and deficiencies with the current alternatives to a financial health score, such as credit scores, and their ability to provide consumers (or lenders) insight into how changes to the consumer's financial data will impact their score. These drawbacks include that there is no what-if analysis. No credit scoring company provides a way for a consumer (or lender) to do a what-if analysis, such as if the consumer's credit data changes by X, calculate the new credit score. Current systems and techniques cannot (independently) calculate a credit score. Credit scoring companies keep their formulas completely hidden making it impossible to calculate the effect of “new” financial data (e.g., taking up a new loan, opening a new line of credit, paying down a mortgage, etc.). Experian (one of the credit scoring companies) even states on their web site that “It's impossible to calculate a credit score yourself, . . . . ” In addition, there is no way to understand how changes in financial data will impact the credit score. Presently, the credit scoring companies only provide very vague and sometimes misleading information about how to improve a credit score. But they never provide any specific information (e.g., if the amount of credit extended to a consumer increased by $10,000, the consumer's credit score will increase by x points), making it impossible to understand how much the credit score will change based on changes in the consumer's financial data. There is no way to know all data sources being used in the calculation of a credit score. The credit scoring companies obfuscate most aspects of their calculation of credit scores, including not listing exactly which data sources are being used to calculate an individual's credit score. Without knowing this, no consumer will know if a change in a financial data source will impact (negatively or positively) their credit score. There are no “two-way” calculations. Sometimes the consumer/lender would like to know how changes in financial data will affect the credit score (how many points up/down), but sometimes they would like to know what changes (in the financial data) are necessary to achieve a certain credit score. It would be of great benefit to a consumer to know what changes they will need to make to their financial data in order to get a certain credit score. For example, the interest rate of a loan/mortgage can very much depend on if a consumer is in the so-called “prime” category or “sub-prime” category with respect to their credit score. In light of the foregoing, a need exists for an improved system and method for providing a simulation or what-if analysis of a consumer's financial health score in an effort to overcome the aforementioned obstacles and deficiencies of conventional credit scores.

Various embodiments of the present disclosure can be configured to target a huge hole in a consumer's ability to understand their own financial health. Although various examples can use a financial health score, further embodiments can be applied to any financial score in further embodiments, even credit scores. By allowing a consumer to enter their own financial data, in various examples, a what-if analysis can calculate the projected FHS to allow the consumer to fully or at least partially understand how changes in their data will impact their financial health score. This can allow the consumer to understand what they need to do in order to get financially healthier so they can become more attractive to lenders and potentially also reduce the interest rate of the loan they might be interested in. Conversely, various embodiments can allow the consumer to enter their projected/desired financial health score and the what-if analysis can calculate and display what financial data is necessary to achieve this financial health score. Various embodiments are the first such system and method to allow the consumer to fully understand their financial situation and what can be done in order to improve (or worsen) their financial health score.

Various embodiments can allow the consumer/lender to not only understand the current financial health score/state of the consumer, but also how changes in the consumer's financial situation (e.g., drop in salary, taking up a new loan, etc.) will influence their financial health. Various embodiments include a novel approach to letting consumers and lenders “see into the financial future” and thereby, for example, reduce the risk of a consumer defaulting on a new loan.

In the description provided below, the FHS will be used as an example for a potential implementation; however, further embodiments can work for any suitable financial scoring algorithm, so the present examples should not be construed as being limiting. In some examples, working with a financial scoring system can be facilitated given that some or all necessary data sources are allowed to be changed.

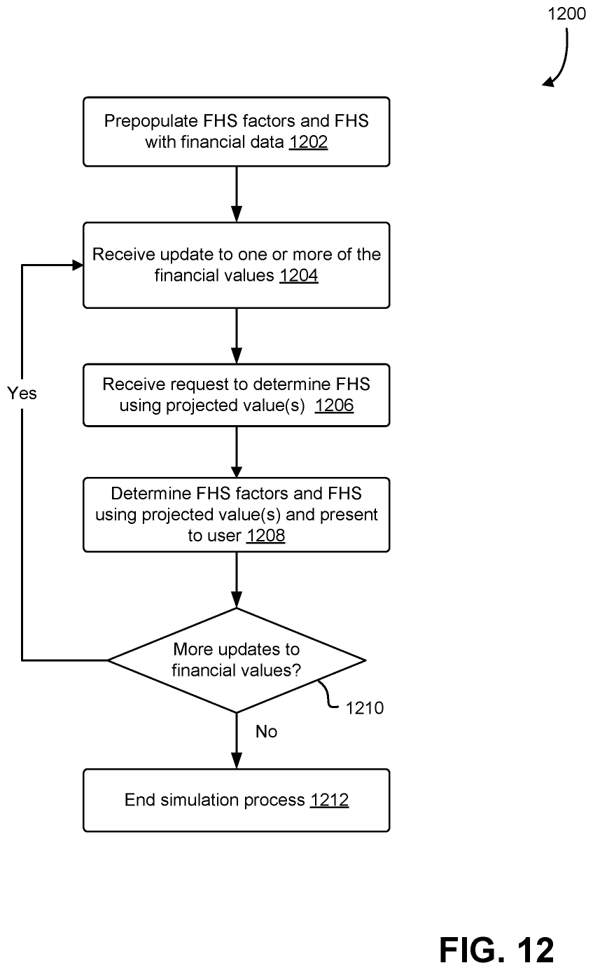

FIG. 12 illustrates example process 1200 for simulating a financial evaluation, such as by calculating a projected FHS, which may be performed by the FHS simulator 134 of the evaluation service 102 described above in reference to FIG. 1.

As the example flow chart indicates, process 1200 may include determining the present value of each of the data sources being used in the calculation of the score, in this example case the FHS, and pre-populating the values, such as in a graphic user interface, such as UI 108 described above in reference to FIG. 1, whereby the values may be displayed to the end user, at operation 1202. In the case of simulating the FHS, the data sources in some embodiments can comprise one or more of the following:
Gross income
Net income
Debt obligations, divided into:
   Beneficial debt
   Neutral debt
   Adverse debt
Savings amount
Total expenses
Liquid reserves
(Number of) Late payments, potentially divided into:
   Mortgages
   Other loans/debt
   Bills (other than loans)
Age of late payments, potentially divided into:
   Mortgages
   Other loans/debt
   Bills (other than loans)

In various embodiments, the end user is able to change some or any/all of these data points (e.g., they can be readable/writeable to the end user). In addition, various examples can determine the present value of the score (in this example the FHS) and display that to the end user. Most financial scores (including both credit scores and the FHS) contains sub scores (referred to herein as FHS factors in our FHS example) and various examples can determine these and display them to the end user as well. The FHS factors or sub scores and the FHS score can be read only values in various embodiments (i.e., the end user cannot change these values). In the case of the FHS, in some embodiments the FHS factors can comprise one or more of the following: a liquid reserves factor, a debt-to-income factor, a total spending factor, a payment history factor, a savings factor, and/or a debt portfolio factor, or a debt factor.

In various examples, the end user can change at least some or any (and all) of the data points to reflect a (projected) financial situation the end user would like to simulate (i.e., create their own what-if analysis). Examples of such situations could be a new income, paying down (or even paying off) debt, putting more/less into savings, etc. Upon entry, the system may receive an update to at least one of the financial values and replace the existing value or values with a projected value(s), at operation 1204. In some embodiments, the financial health score and factors in some examples can be updated automatically as soon as the end-user updates/changes a data point at operation 1208, or the end-user can click a button or make a selection, to get the projected financial health score, and factors in some examples. In this example, the system may receive a request to determine the FHS using the projected values at operation 1206 and may subsequently perform operation 1208. The end result can be that the projected financial health score, and factors in some examples, reflects the new data points. In some cases, process 1200 may include determining if there are any more values to update, at operation 1210. If so, then process 1200 may loop back to operation 1204. If no more updates are requested, then the simulation process may end at 1212.

Having the ability to do this can allow the end user (e.g., consumer, a financial planner, a loan consultant, or anyone else) to create scenarios of new financial situations in order to better understand the impact of financial decisions on the (financial health) score. Such what-if analysis can be desirable in some examples to improve the end user's understanding of both the present financial situation and a potential new financial situation (e.g., if a new loan will cause the end user to become financially unhealthy (and hence might default on the loan), if increasing the liquid reserves will “bump” the end user over a necessary threshold (e.g., to get a new loan with a better rate), if reducing the total spending will allow the end user to pay down some of their debt, etc.).

Sometimes it might be difficult for the end-user to know exactly what the new values would be for each data item. In some embodiments, the system may only ask for a limited set of new data values, or to combine some data items/values, or even split up some data items/values. For example, the system may only request gross (or net) income and use a calculation for determining the net (or gross) income. In some examples, the system may request the combined debt obligations without asking for the specific amounts for beneficial/neutral/adverse debt obligations. This can, in some examples, give the flexibility to customize the what-if analysis to the individual end-user, such that the analysis can be simplified to make it more user friendly. In some embodiments, if the opportunity for the end-user to set new values for each data source are not provided, the projected FHS may only be an approximate score. In some examples this might be preferred though to having to calculate the precise new values for each data point. In various embodiments it can be desirable to give the end user enough flexibility and user friendliness that they use this analysis to better understand their own financial situation. Various examples can encompass and allow for either situation (i.e., either “require” all data sources or a “simplified” set of data sources). In some aspects, a set of simplified values that the user can change to generate a simulated or projected FHS may include yearly gross income, minimum monthly debt payments, other monthly expenses, liquid reserves, and monthly savings. By only allowing the user to adjust these values, in some examples, a more straightforward tool may be created, where the projected FHS may simulate only changes that a user would be likely to make to their financial situation.

Sometimes it can be valuable to use the what-if analysis the opposite way, such that instead of updating the data source values and getting the projected financial health score, the end-user can enter the projected or desired FHS, and the simulator can then display the data source values necessary to obtain that score.

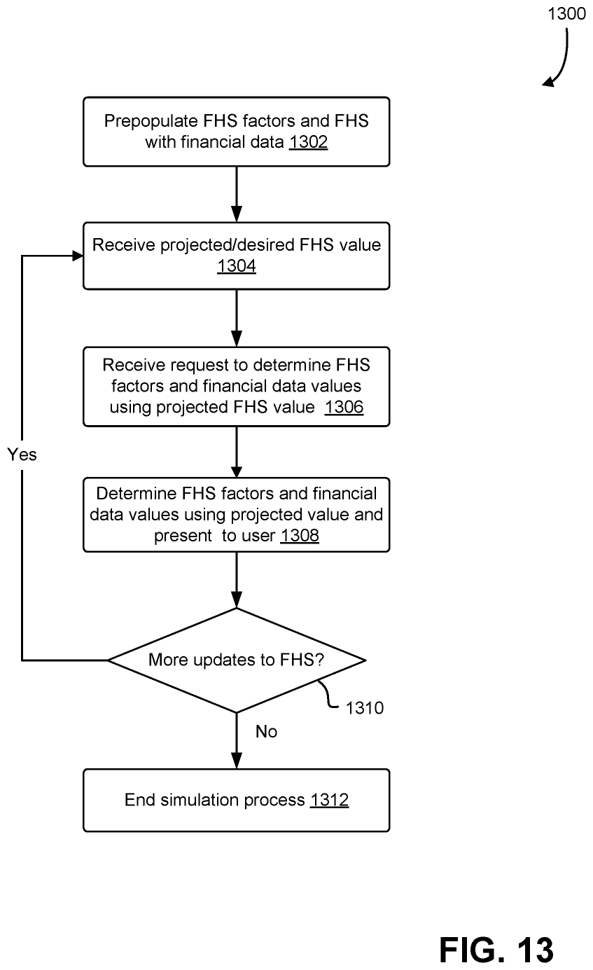

FIG. 13 illustrates example process 1300 for calculating projected data values in given a projected or desired overall financial health score, which may be performed by the FHS simulator 134 of the evaluation service 102 described above in reference to FIG. 1.

As the example flow chart indicates, process 1300 can begin at operation 1302, which can include determining the present value of each of the data sources being used in the calculation of the score, in this case the FHS, and display that to the end user (e.g., prepopulate known financial values). In the case of the FHS the data sources can comprise one or more of the following:
Gross income
Net income
Debt obligations, divided into:
   Beneficial debt
   Neutral debt
   Adverse debt
Total expenses
Savings amount
Liquid reserves
(Number of) Late payments, potentially divided into:
   Mortgages
   Other loans/debt
   Bills (other than loans)
Age of late payments, potentially divided into:
   Mortgages
   Other loans/debt
   Bills (other than loans)

In some examples, financial scores including various credit scores and some embodiments of the FHS, can contain sub scores, called FHS factors in our FHS example, and in various embodiments these can be determined and displayed to the end user as well, such as through UI 108. In various examples, the end user can be restricted from changing any of the data points or the FHS factors (i.e., they can be read only to the end user). In the case of the FHS, the FHS factors can comprise one or more of the following: a liquid reserves factor, a debt-to-income factor, a total spending factor, a payment history factor, a savings factor, and/or a debt portfolio factor, or a debt factor.

In addition, the present value of the score, in this case the FHS, can be determined and displayed to the end user. This data point, the score, can be a read/write value in various examples (i.e., the end user *can* change this value).

The end user can now change the score to reflect the “desired”/projected financial health score they wish to obtain, whereby the system may receive the projected or desired FHS score, at operation 1304. Just as above, in some embodiments the projected data points and FHS factors can be updated as soon as the end-user updates/changes the (financial health) score at operation 1308, or the end-user can click a button (or hit return), at operation 1306, prior to the system determining the financial data values and factors that yield the projected FHS. The result is that the data points and FHS factors are updated to reflect the desired (projected) (financial health) score. Various embodiments encompass and allow for highlighting the data points and FHS factors that changed to make the projected changes easier for the end user to ascertain.

In some cases, process 1300 may include determining if there are any more updates to the FHS, at operation 1310. If so, then process 1300 may loop back to operation 1304. If no more updates are requested, then the simulation process may end at 1312.

Having the ability to do this in some examples can allow the end user (be it a consumer, a financial planner, a loan consultant, or anyone else) to better understand what is necessary to improve upon in order to get to a particular financial health score. Such what-if analysis can be desirable in some examples to improve the end user's understanding of both the present financial situation and how to get to a projected financial situation.

In various embodiments, there are many different ways to get to a particular (financial health) score so there may be many different things to consider when recommending what an end user can/should do. Different end users will have different items that will be easier for them to improve upon, and finding these low hanging fruits will be important to encourage end users to continue to improve upon their financial health. The faster the end user can see they are improving their FHS, the more likely they are to continue to improve their financial health score.

In some embodiments, it is not always necessary to consider all data sources or factors when the consumer would like to know what to do to get to a projected financial health score. Sometimes it will be easier for the consumer to find out how a particular data source (or particular data sources) must be improved upon in order to get to a projected score. Various examples encompass and allow for letting the end-user choose which particular data source(s) they want to consider when determining how to get to a projected score. Allowing the end user to e.g., pick the gross/net income can allow them to understand what new salary they will need (e.g., when considering changing jobs) in order to get a projected financial health score.

Sometimes it might be beneficial to present the end user with a simplified set (rather than the complete set) of data sources and factors when the end user enters a projected financial health score. Presenting only the gross/net income (rather than both), total debt obligations, etc. might be better for the end user to understand. Various embodiments encompass and allow for doing such simplification. Note, however, that simplifying the data sources in some examples means only approximate data points can be provided to achieve the projected financial health score. In some aspects, a set of simplified values that the system will modify to reach the projected FHS may include yearly gross income, minimum monthly debt payments, other monthly expenses, liquid reserves, and monthly savings. By only allowing adjustments to these values, in some examples, a more straightforward tool may be created, where the projected financial data values may simulate only changes that a user would be likely to make to their financial situation.

Various embodiments can be offered as a SaaS solution, but can also be “stand-alone” (i.e., running on a consumer's/lender's computer), a “networked” solution (e.g., running inside a company's private network), or any other type of technical solution.

The example methods shown and described herein can be performed on various suitable systems. For example, one embodiment can include a financial health score server (virtual or non-virtual), which can be operably connected to a plurality of user devices via a network (e.g., comprising the Internet, Wi-Fi, LAN, or the like). The financial health score server and/or user devices can be operably connected to one or more data source servers, which can include servers associated with banks, credit reporting services, employers, vendors, creditors, lenders, brokers, and the like. Such data source servers can be configured to provide data (e.g., financial data) regarding one or more users as discussed herein (e.g., directly to the financial health score server, to one or more of the user devices, or the like).

One or more steps of the example methods shown and described herein can be performed on one or more of such devices or servers. Accordingly, use of terms like “we” herein should be construed to include, in various embodiments, a computer implemented method (e.g., via a non-transitory computer readable medium) that when executed by a processor can cause the performance of at least a portion of a method discussed herein. Additionally, in various embodiments, any suitable portions of such methods can be performed automatically by a computing device (e.g., financial health score server) without user input or can be performed in response to user input.

When dealing with a consumer's financial data, security of such data can be desirable for an application providing a financial health score or evaluation. In some cases data security may be important for all steps of obtaining the financial data, determining one or more financial factors, providing a score simulator, and so on. In some examples, the consumer owns all the data in an application and it is the responsibility of the company developing the application or applications to make sure the data is kept secure and only showed to the consumer—or to the people the consumer allows access to their data. Accordingly, in various embodiments, data in the described system can be secure both in-transit and at-rest and can be encrypted whenever/wherever possible.

Embodiments of the present disclosure can be described in view of the following clauses:
1. A financial health evaluation system, comprising:
one or more processors;
memory that stores computer-executable instructions that, if executed, cause the one or more processors to:
   obtain financial data relating to an entity, the financial data comprising asset information, debt information, and revolving account information, wherein the financial data comprises complete financial data for the entity for a time period;
   classify the financial data into one of a plurality of data categories, wherein at least one of the data categories is used to determine each of six factors, the six factors comprising: a debt-to income factor, a total spending factor, one of a debt portfolio factor or a debt factor, a saving factor, a liquid reserves factor, and a payment history factor;
   using the classified financial data, determine a ratio for each of the six factors;
   determine a score for each of the six factors based on the ratio for the respective factor, wherein determining the score for at least two of the six factors comprises:
      using a first equation to determine the score for values of the ratio for a first range of ratio values; and
      using a second equation to determine the score for values of the ratio for a second range of ratio values;
   associate a weight to each score of the six scores based on a relative importance of the associated factor; and
   combine the weighted scores to generate a financial health score.
2. The system of clause 1, wherein the memory stores additional computer-executable instructions that, if executed, cause the one or more processors to:
obtain the financial data relating to the entity, classifying the financial data into one of the six factors; determining the ratio for each of the six factors, determining the score for each of the six factors, associating the weight to each score of the six scores, and generating the financial health score periodically on a monthly basis; and
averaging the financial health scores over a second time period that is at least the length of two months to generate an average financial health score.
3. The system of clause 1 or 2, wherein the memory stores additional computer-executable instructions that, if executed, cause the one or more processors to:
obtain the financial data relating to the entity, classifying the financial data into one of the six factors; determining the ratio for each of the six factors, determining the score for each of the six factors, associating the weight to each score of the six scores, and generating the financial health score periodically on a monthly basis; and
combine the financial health scores over a second time period that comprises the past six months to generate a six month financial health score.
4. The system of any of clauses 1-3, wherein the computer-executable instructions that, if executed, cause the one or more processors to determine a score for each of the six factors based on the ratio for the respective factor further comprise additional instructions, that, if executed, further cause the one or more processors:
compare each of the six ratios for the six factors to an objective benchmark value to generate the six factor scores.
5. The system of any of clauses 1-4, wherein the memory stores additional computer-executable instructions that, if executed, cause the one or more processors to:
associate the weight to each score of the six scores based on a relative importance of the associated factor, wherein the importance is ranked from highest to lowest in the following order: the liquid reserves factor, the debt-to-income factor, the total spending factor, the payment history factor, the savings factor, and the debt portfolio factor of the debt factor.
6. The system of any of clauses 1-5, wherein the memory stores additional computer-executable instructions that, if executed, cause the one or more processors to:
obtain an indication that the financial data comprises complete financial data for the entity for the time period.
7. The system of any of clauses 1-6, wherein the first equation comprises one of a linear equation, a quadratic equation, a cubic equation, a logarithmic equation, or a hyperbolic equation; and the second equations comprises another of the linear equation, the quadratic equation, the cubic equation, the logarithmic equation, or the hyperbolic equation.
8. The system of any of clauses 1-7, wherein the memory stores additional computer-executable instructions that, if executed, cause the one or more processors to:
determine the debt-to income ratio value by: dividing debt obligations by gross or net income for the time period; and
determine the debt-to-income factor by:
   using a first equation to determine the debt-to-income score for values of the debt-to-income ratio for a first range of debt-to-income ratio values;
   using a second equation to determine the debt-to-income score for values of the debt-to-income ratio for a second range of debt-to-income ratio values; and
   using at least one of the first equation, the second equation, or a third equation to determine the debt-to-income score for values of the debt-to-income ratio for a third range of debt-to-income ratio values.
9. The system of any of clauses 1-8, wherein the memory stores additional computer-executable instructions that, if executed, cause the one or more processors to:
determine the liquid reserves ratio value by: dividing a liquid reserves value by a total spending value for the time period; and
determine the liquid reserves factor by: comparing the liquid reserves ratio value to a liquid reserves objective benchmark.
10. The system of any of clauses 1-9, wherein the memory stores additional computer-executable instructions that, if executed, cause the one or more processors to:
determine the savings ratio value by: dividing a savings amount by gross income for the time period; and
determine the savings factor by: using a linear equation, between a benchmark savings value that indicates healthy savings and a minimum savings value, to modify the savings ratio value.
11. The system of any of clauses 1-10, wherein the memory stores additional computer-executable instructions that, if executed, cause the one or more processors to:
determine the total spending ratio value by: dividing net cash flow by net income for the time period, wherein the net cash flow includes the net income minus a savings amount minus a total spending amount for the time period.
12. The system of any of clauses 1-11, wherein the memory stores additional computer-executable instructions that, if executed, cause the one or more processors to:
determine the debt portfolio ratio value by: dividing an adverse debt value by a gross or net income value if the entity is associated with no beneficial debt, and dividing the adverse debt by the a beneficial debt value if the entity is associated with a non-zero beneficial debt value.
13. The system of any of clauses 1-12, wherein the memory stores additional computer-executable instructions that, if executed, cause the one or more processors to:
determine the debt ratio value by:
setting the debt ratio to one when there is no total adverse debt for the time period associated with the entity; and
dividing an adverse debt payment value by a total adverse debt when there is a total adverse debt for the time period associated with the entity.
14. The system of any of clauses 1-13, wherein the memory stores additional computer-executable instructions that, if executed, cause the one or more processors to:
determine the payment history ratio value by:
categorizing late payments associated with the entity into one of at least two different categories;
determining an impact value for the late payments in each of the at least two categories;
determining a weight for each of the at least two categories; and
combining the at least two impact values to yield the payment history factor.
15. The system of any of clauses 1-14, wherein the memory stores additional computer-executable instructions that, if executed, cause the one or more processors to: determine the payment history ratio value by: generating an impact value for the late payments based on an age of the late payments, wherein the payment history ratio value is based on the impact value.
16. A method for determining a balanced financial health score, comprising:
obtaining financial data relating to an entity, the financial data comprising asset information, debt information, and revolving account information for a time period;
classifying the financial data into one of a plurality of data categories, wherein at least one of the data categories is used to determine each of six factors, the six factors comprising: debt-to income, total spending, debt or saving, liquid reserves, and payment history;
using the classified financial data, determining a ratio for at least three of the six factors;
determining a score for at least three of the six factors based on the ratio for at least three of the six factors, wherein determining the score for at least one of the six factors comprises:
   using a first equation to determine the score for values of the ratio for a first range of ratio values; and
   using a second equation to determine the score for values of the ratio for a second range of ratio values; and
combining the scores to generate a financial health score.
17. The method of clause 16, further comprising:
obtaining the financial data relating to the entity, classifying the financial data into one of the plurality of categories; determining the ratio for each of the at least three factors, determining the score for each of the at least three factors, associating the weight to each of the at least three scores, and generating the financial health score periodically every first length of time; and
combine the financial health scores over a second length of time that is at least twice the length of the first length to generate a long term financial health score.
18. The method of clause 16 or 17, further comprising:
obtaining the financial data relating to the entity, classifying the financial data into one of the plurality of categories; determining the ratio for each of the at least three factors, determining the score for each of the at least three factors, associating the weight to each of the at least three scores, and generating the financial health score for a rolling time window.
19. The method of any of clauses 16-18, further comprising:
associating a weight to each of the at least three scores based on a relative importance of the associated factor; and
combining the weighted scores to generate a financial health score.
20. The method of any of clauses 16-19, wherein the financial data comprises complete financial data for the entity for at least the past two years.
21. The method of any of clauses 16-20, wherein the at least three factors comprise the debt-to income factor, wherein determining the debt-to income factor comprises:
determining a ratio of income to debt obligations; and
   using a first equation to determine the debt-to-income score for values of the debt-to-income ratio for a first range of debt-to-income ratio values; and
   using a second equation to determine the debt-to-income score for values of the debt-to-income ratio for a second range of debt-to-income ratio values; and
22. The method of any of clauses 16-21, wherein the at least three factors comprise the liquid reserves factor, wherein determining the liquid reserves factor comprises:
determining a ratio between a liquid reserves value and a total spending value for the time period; and
comparing the ratio to a liquid reserves objective benchmark.
23. The method of any of clauses 16-22, wherein the at least three factors comprise the savings factor, wherein determining the savings factor comprises:
determining a ratio of a savings amount and income for the time period; and comparing the ratio to a benchmark savings value that indicates healthy savings and a minimum savings value.
24. The method of any of clauses 16-23, wherein the at least three factors comprise the total spending factor, wherein determining the total spending factor comprises:
determining a ratio of net cash flow and net income for the time period, wherein the net cash flow includes the net income minus a savings amount minus a total spending amount for the time period; and
comparing the ratio to at least one benchmark total spending value.
25. The method of any of clauses 16-24, wherein the at least three factors comprise the debt portfolio factor, wherein determining the total debt portfolio factor comprises:
determining a ratio between an adverse debt value and an income value or between the adverse debt value and a beneficial debt value; and
comparing the ratio to at least one debt portfolio value.
26. The method of any of clauses 16-25, wherein the at least three factors comprise the payment history factor, wherein determining the payment history factor comprises:
categorizing late payments associated with the entity into one of at least two different categories;
determining an impact value for the late payments in each of the at least two categories;
determining a weight for each of the at least two categories; and
combining the at least two impact values to yield the payment history factor.
27. The system of any of clauses 16-26, wherein the memory stores additional computer-executable instructions that, if executed, cause the one or more processors to:
determine the debt ratio value by:
   setting the debt ratio to one when there is no total adverse debt for the time period associated with the entity; and
   dividing an adverse debt payment value by a total adverse debt when there is a total adverse debt for the time period associated with the entity.
28. A method for determining a financial health score, comprising:
obtaining financial data relating to an entity, the financial data comprising asset information, debt information, and revolving account information for a time period;
debt-to income, total spending, debt or saving, liquid reserves, and payment history;
using the classified financial data, determining a ratio for at least two of: a debt-to income factor, a total spending factor, a debt or debt portfolio factor, a saving factor, a liquid reserves factor, or a payment history factor;
determining a score for at least two of the six factors based on the ratio for at least two of the six factors, wherein determining the score for at least one of the six factors comprises:
   using a first equation to determine the score for values of the ratio for a first range of ratio values;
   using a second equation to determine the score for values of the ratio for a second range of ratio values; and
combining the scores to generate a financial health score.

Embodiments of the present disclosure can be described in view of the following clauses:
1. A financial health simulation system, comprising:
one or more processors;
memory that stores computer-executable instructions that, if executed, cause the one or more processors to:
   obtain a request from a user device to simulate a desired value for a financial health score for an entity;
   responsive to the request, access financial data associated with the entity;
   determine a first financial health score using the financial data, wherein the financial health score comprises a combination of values from at least three of a debt-to income factor, a total spending factor, a debt or debt portfolio factor, a saving factor, a liquid reserves factor, or a payment history factor;
   using the desired value for the financial health score, change at least one of a subset of financial data values used to calculate at least one of the three of the debt-to income factor, the total spending factor, the debt or debt portfolio factor, the saving factor, the liquid reserves factor, or the payment history factor to yield the desired value for the financial health score; and
   provide an indication of the changed at least one of the subsets of financial values to the user device.
2. The system of clause 1, wherein the subset of financial values comprises:
a yearly gross income, minimum monthly debt payments, other monthly expenses, liquid reserves, and monthly savings.
3. The system of clause 1 or 2, wherein the subset of financial values comprises at least one of:
a yearly gross income, minimum monthly debt payments, other monthly expenses, liquid reserves, or monthly savings.
4. The system of any of clauses 1-3, wherein the memory stores additional computer-executable instructions that, if executed, cause the one or more processors to:
provide multiple sets of indications of changes to at least one of the subsets of financial values to the user device that will result in the desired financial health score.
5. The system of any of clauses 1-4, wherein the memory stores additional computer-executable instructions that, if executed, cause the one or more processors to:
obtain a second request to change at least one value of the subset of financial values to a second value; and
response to obtaining the second request, recalculating the financial health score using the at least one second value.
6. The system of any of clauses 1-5, wherein the memory stores additional computer-executable instructions that, if executed, cause the one or more processors to:
provide the values of each of the subsets of financial values to the user device
7. The system of clause 6, wherein the memory stores additional computer-executable instructions that, if executed, cause the one or more processors to:
obtain a second request to change at least one value of the subset of financial values to a second value; and
responsive to the obtaining the second request, adjust at least one other value of the subset of financial values such that the subset of financial values still yield the desired financial health score.
8. A financial health simulation system, comprising:
one or more processors;
memory that stores computer-executable instructions that, if executed, cause the one or more processors to:
   obtain a request from a user device to simulate an impact on a financial health score of an entity caused by a change in at least one of a subset of financial data values used to determine the financial health score;
   obtain a past financial health score including values for at least three of a debt-to income factor, a total spending factor, a debt or debt portfolio factor, a saving factor, a liquid reserves factor, or a payment history factor, wherein the change in at least one of the subset of financial data values affects at least one of the debt-to income factor, the total spending factor, the debt or debt portfolio factor, the saving factor, the liquid reserves factor, or the payment history factor;
   calculate a simulated financial health score using the at least one changed value for at least one of the subset of financial data values; and
   provide an indication of the simulated financial health score to the user device.
9. The system of clause 8, wherein the subset of financial values comprises:
a yearly gross income, minimum monthly debt payments, other monthly expenses, liquid reserves, and monthly savings.
10. The system of clause 8 or 9, wherein the subset of financial values comprises at least one of:
a yearly gross income, a minimum monthly debt payment, another monthly expense, liquid reserves, and monthly savings.
11. The system of any of clauses 8-10, wherein the memory stores additional computer-executable instructions that, if executed, cause the one or more processors to:
provide at least two indications of the simulated financial health score corresponding to at least two different values of the at least one changed value for at least one of the subset of financial data values.
12. The system of any of clauses 8-11, wherein the memory stores additional computer-executable instructions that, if executed, cause the one or more processors to:
determine the past financial health score by determining and combining at least three of the debt-to income factor, the total spending factor, the debt or debt portfolio factor, the saving factor, the liquid reserves factor, or the payment history factor.
13. The system of clause 12, wherein the memory stores additional computer-executable instructions that, if executed, cause the one or more processors to:
obtain a plurality of financial data values directly from one or more financial sources, wherein the plurality of financial data values are used to calculate at least three of the debt-to income factor, the total spending factor, the debt or debt portfolio factor, the saving factor, the liquid reserves factor, or the payment history factor.
14. The system of clause 13, wherein the memory stores additional computer-executable instructions that, if executed, cause the one or more processors to:
classify the plurality of financial data values into one of a plurality of categories, wherein individual categories of the plurality of categories correspond to at least one of the debt-to income factor, the total spending factor, the debt or debt portfolio factor, the saving factor, the liquid reserves factor, or the payment history factor.
15. The system of any of clauses 8-14, wherein the memory stores additional computer-executable instructions that, if executed, cause the one or more processors to:
provide the values of each of the subset of financial values to the user device.
16. The system of clause 15, wherein the memory stores additional computer-executable instructions that, if executed, cause the one or more processors to:
provide a user interface that includes selectable items to change each of the subset of financial values to the user device, wherein upon receiving a change to at least one of the subsets of financial values, the computer-executable instructions that, if executed, further cause the one or more processors to:
   determine a revised financial health score using the change to at least one of the subsets of financial values.
17. The system of any of clauses 8-16, wherein the memory stores additional computer-executable instructions that, if executed, cause the one or more processors to:
obtain a second request to change at least one value of the subset of financial values to a second value; and
responsive to the obtaining the second request, determine a revised financial health score using the second value.
18. A method for simulating changes to a financial health score, comprising:
obtaining a request from a user device to simulate an impact on a financial health score of an entity caused by a change in at least one of a subset of financial data values used to determine the financial health score;
determining a past financial health score by combining values for at least three of a debt-to income factor, a total spending factor, a debt or debt portfolio factor, a saving factor, a liquid reserves factor, or a payment history factor, wherein the change in at least one of the subset of financial data values affects at least one of the debt-to income factor, the total spending factor, the debt or debt portfolio factor, the saving factor, the liquid reserves factor, or the payment history factor;
calculating a simulated financial health score using the at least one changed value for at least one of the subset of financial data values; and
providing the simulated financial health score and the subset of financial data values to the user device.
19. The method of clause 18, wherein the subset of financial values comprises at least two of:
a yearly gross income, minimum monthly debt payments, other monthly expenses, liquid reserves, and monthly savings.
20. The method of clause 18 or 19, further comprising:
providing a range of simulated financial health scores corresponding to a range of different values for the at least one of the subsets of financial data values.
21. The method of any of clauses 18-20, further comprising:
obtaining a plurality of financial data values directly from one or more financial sources, wherein the plurality of financial data values are used to calculate at least three of the debt-to income factor, the total spending factor, the debt or debt portfolio factor, the saving factor, the liquid reserves factor, or the payment history factor.
22. The method of any of clauses 18-21, further comprising:
providing options to change each of the subset of financial values to the user device, wherein upon receiving a change to at least one of the subsets of financial values, the method further comprises:
determining a revised financial health score using the change to at least one of the subsets of financial values.

Embodiments of the present disclosure can be described in view of the following clauses:
1. A financial evaluation system, comprising:

one or more processors;

memory that stores computer-executable instructions that, if executed, cause the one or more processors to:

obtain financial data relating to an entity, the financial data comprising income information and debt information for a time period;

determine an income value for the entity for the time period using the income information;

obtain interest rate information indicating an interest rate;

based on the interest rate, separate the debt information into beneficial debt and adverse debt based on the interest rate, wherein beneficial debt is associated with a beneficial interest rate that is less than the interest rate plus a first amount and adverse debt is associated with an adverse interest rate that is greater than the interest rate plus a second amount that is greater than the first amount;

determine a debt portfolio ratio using the adverse debt, wherein the debt portfolio ratio comprises a first ratio of adverse debt to the income value when the entity is not associated with any beneficial debt and a second ratio of adverse debt to the beneficial debt when the entity is associated with beneficial debt;

determine a debt portfolio score for the entity using the debt portfolio ratio by comparing the debt portfolio ratio to at least one benchmark value; and

use the debt portfolio score to generate a financial evaluation of the entity.
2. The system of clause 1, wherein the at least one benchmark comprises a low threshold value and an upper threshold value that collectively define a range of the debt portfolio ratio, and a middle threshold that separates the range into a first band and a second band.
3. The system of clause 2, wherein the computer-executable instructions that, if executed, cause the one or more processors to determine the debt portfolio score for the entity using the debt portfolio ratio by comparing the debt portfolio ratio to the at least one benchmark value further comprise additional instructions, that, if executed, further cause the one or more processors:

determine the debt portfolio factor by using a first equation when the debt portfolio ratio is in the first band and a second equation when the debt portfolio ratio is in the second band.
4. The system of any of clauses 1-3, wherein the beneficial debt comprises neutral debt, wherein the neutral debt includes at least one of alimony, palimony, or child support debt.
5. The system of any of clauses 1-4, wherein the memory stores additional computer-executable instructions that, if executed, cause the one or more processors to:

confirm that the financial data comprises complete financial data relating to income and debts for the entity for the time period;
6. The system of any of clauses 1-5, wherein the memory stores additional computer-executable instructions that, if executed, cause the one or more processors to:

receive an indication of a schedule to generate the financial evaluation, the schedule indicating a period by which to update the financial evaluation; and

generate the financial evaluation of the entity periodically according to the schedule.
7. The system of clause 6, wherein the time period is greater than the period.
8. The system of any of clauses 1-7, wherein the memory stores additional computer-executable instructions that, if executed, cause the one or more processors to:

determine at least one of a debt-to income factor, a total spending factor, a saving factor, a liquid reserves factor, or a payment history factor; and

generate the financial evaluation further based on a combination of the debt portfolio factor and at least one of the debt-to income factor, the total spending factor, the saving factor, the liquid reserves factor, or the payment history factor.
9. The system of any of clauses 1-8, wherein the financial data is obtained directly from one or more financial institutions to ensure accuracy of the financial data.
10. The system of any of clauses 1-9, wherein the interest rate comprises one of a Federal Funds Rate, a Secured Overnight Financing Rate, a prime rate, or a rate on benchmark U.S. Treasury securities.
11. A financial evaluation system, comprising:

one or more processors;

memory that stores computer-executable instructions that, if executed, cause the one or more processors to:

obtain financial data relating to an entity, the financial data comprising debt information and debt payment information for a time period,

based on a benchmark interest rate, classify a subset of the debt information as adverse debt, wherein the adverse debt is associated with an adverse debt interest rate that is greater than an adverse interest rate threshold value, wherein the adverse interest rate threshold value is based on the benchmark interest rate;

identify a subset of the payment information that corresponds to the adverse debt as adverse debt payments;

determine a debt ratio based on a total of the adverse debt, wherein the debt ratio comprises 1 when the total adverse debt equals zero, and the debt ratio comprises a ratio of adverse debt payments to total adverse debt when the total adverse debt does not equal zero;

determine a debt factor score for the entity using the debt ratio, wherein the debt factor ratio is compared to at least one benchmark value to determine the debt factor score; and

use the debt factor score to generate a financial evaluation of the entity.
12. The system of clause 11, wherein the at least one benchmark comprises a low threshold value and an upper threshold value that collectively define a range of the debt factor ratio, and a middle threshold that separates the range into at least a first band and a second band.
13. The system of clause 12, wherein the computer-executable instructions that, if executed, cause the one or more processors to determine the debt factor score for the entity using the debt ratio by comparing the debt factor ratio to the at least one benchmark value further comprise additional instructions, that, if executed, further cause the one or more processors:

determine the debt factor by using a first equation when the debt ratio is in the first band and a second equation when the debt ratio is in the second band.
14. The system of any of clauses 11-13, wherein the memory stores additional computer-executable instructions that, if executed, cause the one or more processors to:

obtain an indication that the financial data comprises complete financial data relating to the debt information and the debt payment information for the entity for the time period;
15. The system of any of clauses 11-14, wherein the memory stores additional computer-executable instructions that, if executed, cause the one or more processors to:

receive an indication of a schedule to generate the financial evaluation, the schedule indicating a period by which to update the financial evaluation; and

generate the financial evaluation of the entity periodically according to the schedule.
16. The system of clause 15, wherein the time period of the financial data is greater than the period.
17. The system of any of clauses 11-16, wherein the memory stores additional computer-executable instructions that, if executed, cause the one or more processors to:

determine at least one of a debt-to-income factor, a total spending factor, a saving factor, a liquid reserves factor, or a payment history factor; and

generate the financial evaluation further based on a combination of the debt factor and at least one of the debt-to-income factor, the total spending factor, the saving factor, the liquid reserves factor, or the payment history factor.
18. The system of any of clauses 11-17, wherein the financial data is obtained directly from one or more financial institutions to ensure accuracy of the financial data.
19. The system of any of clauses 11-18, wherein the benchmark interest rate comprises one of a Federal Funds Rate, a Secured Overnight Financing Rate, a prime rate, or a rate on benchmark U.S. Treasury securities.
20. A method for classify debt for generating a financial evaluation of an entity, comprising:

obtaining financial data, associated with an entity, for a time period, wherein the financial data comprises at least one debt item associated with a debt item interest rate;

determining at least one interest rate threshold based on a benchmark interest rate value obtained from a public source;

comparing the debt item interest rate with the at least one interest rate threshold to produce an interest rate comparison;

based on the interest rate comparison, generating a debt item classification, wherein the debt item classification comprises one of beneficial debt or adverse debt; and

using the classification of the debt item, generating a financial evaluation of the entity, wherein if the debt classification comprises beneficial debt, at least one aspect of the financial evaluation is better than if the debt classification comprises adverse debt.
21. The method of clause 20, wherein the at least one interest rate threshold comprises a beneficial interest rate threshold and an adverse interest rate threshold; and

based on the interest rate comparison, generating a debt item classification for the debt item, wherein the debt item classification comprises one of beneficial debt, neutral debt, or adverse debt, wherein

beneficial debt comprises a debt item that has an interest rate that is less than the beneficial debt interest rate threshold,

neutral debt comprises s a debt item that has an interest rate that is greater than the beneficial debt interest rate threshold but less than the adverse interest rate threshold, and

adverse debt comprises a debt item that has an interest rate that is greater than the adverse debt interest rate threshold.
22. The method of clause 21, further comprising:

determining the beneficial debt interest rate threshold by adding a first value to the benchmark interest rate value
23. The method of clause 22, further comprising:

determining the adverse debt interest rate threshold by adding a second value to the benchmark interest rate value, wherein the second value is greater than the first value.
24. The method of any of clauses 20-23, further comprising:

obtaining the benchmark interest rate value from the public source.
25. The method of any of clauses 20-24, further comprising:

obtaining a second benchmark interest rate value from the public source; upon determining that the second benchmark interest rate is different than the benchmark interest rate:

determining at least one second interest rate threshold based on the second benchmark interest rate value;

comparing the debt item interest rate with the at least one second interest rate threshold to produce a second interest rate comparison; and

based on the second interest rate comparison, generating a second debt item classification, wherein the second debt item classification comprises one of beneficial debt or adverse debt.

Embodiments of the present disclosure can be described in view of the following clauses:
1. A financial health evaluation system, comprising:

one or more processors; and

memory that stores computer-executable instructions that, if executed, cause the one or more processors to:

obtain financial data relating to an entity, the financial data comprising a plurality of transactions for a time period;

categorize each of the plurality of transactions into one of a plurality of data categories, the plurality of categories comprising gross income, net income, debt, savings, expenses, liquid reserves, and late payments;

use the plurality of data categories to determine a plurality of factor ratios, wherein each of the plurality of factor ratios comprises a relative metric of an aspect of a financial health evaluation;

convert each of the plurality of factor ratios to a factor score;

associate a weight to each of the plurality of factors scores to generate a plurality of weighted factor scores; and

combine the plurality of weighted factors scores to generate the financial health evaluation.
2. The system of clause 1, wherein the memory stores additional computer-executable instructions that, if executed, cause the one or more processors to:

using values from at least two of the plurality of data categories to determine at least one interim value; and

determining at least one of the plurality of factor ratios using the at least one interim value.
3. The system of clause 2, wherein the at least one interim value comprises at least one of a net cash flow value, an adverse debt value, a beneficial debt value a neutral debt value, or an adverse debt payment value.
4. The system of any of clauses 1-3, wherein the obtain financial data relating to the entity comprises at least one account balance, wherein the memory stores additional computer-executable instructions that, if executed, cause the one or more processors to:

categorize the at least one account balance into one of the plurality of data categories.
5. The system of any of clauses 1-4, wherein the computer-executable instructions that, if executed, cause the one or more processors to obtain financial data relating to the entity, further comprise instructions that, if executed, cause the one or more processors to:

obtain the financial data directly from a financial entity.
6. The system of any of clauses 1-5, wherein the computer-executable instructions that, if executed, cause the one or more processors to obtain financial data relating to the entity, further comprise instructions that, if executed, cause the one or more processors to:

obtain the financial data directly from multiple financial entities; wherein the memory stores additional computer-executable instructions that, if executed, cause the one or more processors to:

obtain a confirmation that all transactions from the multiple financial entities for the time period have been categorized.
7. The system of any of clauses 1-6, wherein the plurality of factor ratios comprise a debt-to-income factor ratio, a debt factor or a debt portfolio factor ratio, a total spending factor ratio, a saving factor ratio, and a liquid reserves factor ratio.
8. The system of any of clauses 1-7, wherein the memory stores additional computer-executable instructions that, if executed, cause the one or more processors to:

further categorize at least one transaction as at least one of an important late payment or a less important late payment.
9. The system of any of clauses 1-8, wherein the memory stores additional computer-executable instructions that, if executed, cause the one or more processors to:

categorize at least one transaction as a late payment and associate a number of the at least one late payment and an age of the at least one late payment with the at least one transaction to generate a late payment record, wherein the late payment record is used to determine a payment history factor as part of the financial health evaluation.
10. A method for classifying financial data to determine a financial health evaluation, comprising:

obtaining financial data relating to an entity, the financial data comprising a plurality of transactions and at least one account balance for a time period;

categorizing each of the plurality of transactions and the at least one account balance into one of a plurality of data categories, the plurality of categories comprising gross income, net income, debt, savings, expenses, liquid reserves, and late payments;

using the plurality of data categories to determine a plurality of factor scores, wherein each of the plurality of factor scores comprises a relative metric of an aspect of a financial health evaluation;

associating a weight to each of the plurality of factors scores to generate a plurality of weighted factor scores; and

combining the plurality of weighted factors scores to generate the financial health evaluation.
11. The method of clause 10, further comprising:

using values from at least two of the plurality of data categories to determine at least one interim value; and

determining at least one of the plurality of factor scores using the at least one interim value.
12. The method of clause 11, wherein the at least one interim value comprises at least one of a net cash flow value, an adverse debt value, a beneficial debt value a neutral debt value, or an adverse debt payment value.,
13. The method of any of clauses 10-12 wherein obtaining financial data relating to the entity further comprises obtaining the financial data directly from a financial entity.
14. The method of any of clauses 10-13, wherein obtaining financial data relating to the entity further comprises:

obtaining the financial data directly from multiple financial entities; wherein the memory method further comprises:

determining that all transactions from the multiple financial entities for the time period have been categorized.
15. The method of any of clauses 10-14, wherein the plurality of factor scores comprise at least three of debt-to-income factor, a debt factor or a debt portfolio factor, a total spending factor, a saving factor, and a liquid reserves factor.
16. The method of any of clauses 10-15, further comprising:

further categorizing at least one transaction as at least one of a mortgage late payment, another loan late payment, or a bill late payment, and associating a relative importance to the at least one transaction based on whether the categorization;

determine a late payment history factor score using the at least one transaction in combination with the associated relative weight; and

combine the plurality of weighted factors scores and the late payment history factor scores to generate the financial health evaluation.
17. The method of clause 16, further comprising:

determining an age of the at least one transaction, wherein determining the late payment history factor score is further based on the age of the at least one transaction.
18. The method of any of clauses 10-17, further comprising:

further categorizing the at least one account balance as one of beneficial debt, neutral debt or adverse debt, wherein determining the debt factor or debt portfolio factor score is based on a total of the adverse debt account balances.
19. The method of any of clauses 10-18, further comprising:

further categorizing the at least one account balance as one of beneficial debt or adverse debt, wherein determining the debt factor or debt portfolio factor score is based on a total of the adverse debt account balances.
20. A financial health evaluation system, comprising:

one or more processors; and

memory that stores computer-executable instructions that, if executed, cause the one or more processors to:

obtain financial data relating to an entity, the financial data comprising a plurality of transactions and at least one account balance for a time period;

categorize each of the plurality of transactions and the at least one account balance into one of a plurality of data categories, the plurality of categories comprising gross income, net income, debt, savings, expenses, liquid reserves, and late payments;

use the plurality of data categories to determine a plurality of factor scores, wherein each of the plurality of factor scores comprises a relative metric of an aspect of a financial health evaluation; and

combine the plurality of factors scores to generate the financial health evaluation.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments. Additionally, elements that are specifically shown in example embodiments should be construed to cover embodiments that comprise, consist essentially of, or consist of such elements, or such elements can be explicitly absent from further embodiments. Accordingly, the recitation of an element being present in one example should be construed to support some embodiments where such an element is explicitly absent.

1. A financial health simulation system, comprising:
one or more processors;
memory that stores computer-executable instructions that, if executed, cause the one or more processors to:
obtain a request from a user device to simulate a desired value for a financial health score for an entity;
responsive to the request, access financial data associated with the entity;
determine a first financial health score using the financial data, wherein the financial health score comprises a combination of values from at least three of a debt-to income factor, a total spending factor, a debt or debt portfolio factor, a saving factor, a liquid reserves factor, or a payment history factor;
using the desired value for the financial health score, change at least one of a subset of financial data values used to calculate at least one of the three of the debt-to income factor, the total spending factor, the debt or debt portfolio factor, the saving factor, the liquid reserves factor, or the payment history factor to yield the desired value for the financial health score; and
provide an indication of the changed at least one of the subsets of financial values to the user device.

2. The system of claim 1, wherein the subset of financial values comprises:
a yearly gross income, minimum monthly debt payments, other monthly expenses, liquid reserves, and monthly savings.

3. The system of claim 1, wherein the subset of financial values comprises at least one of:
a yearly gross income, minimum monthly debt payments, other monthly expenses, liquid reserves, or monthly savings.

4. The system of claim 2, wherein the memory stores additional computer-executable instructions that, if executed, cause the one or more processors to:
provide multiple sets of indications of changes to at least one of the subsets of financial values to the user device that will result in the desired financial health score.

5. The system of claim 1, wherein the memory stores additional computer-executable instructions that, if executed, cause the one or more processors to:
obtain a second request to change at least one value of the subset of financial values to a second value; and
response to obtaining the second request, recalculating the financial health score using the at least one second value.

6. The system of claim 1, wherein the memory stores additional computer-executable instructions that, if executed, cause the one or more processors to:
provide the values of each of the subsets of financial values to the user device

7. The system of claim 6, wherein the memory stores additional computer-executable instructions that, if executed, cause the one or more processors to:
obtain a second request to change at least one value of the subset of financial values to a second value; and
responsive to the obtaining the second request, adjust at least one other value of the subset of financial values such that the subset of financial values still yield the desired financial health score.

8. A financial health simulation system, comprising:
one or more processors;
memory that stores computer-executable instructions that, if executed, cause the one or more processors to:
obtain a request from a user device to simulate an impact on a financial health score of an entity caused by a change in at least one of a subset of financial data values used to determine the financial health score;
obtain a past financial health score including values for at least three of a debt-to income factor, a total spending factor, a debt or debt portfolio factor, a saving factor, a liquid reserves factor, or a payment history factor, wherein the change in at least one of the subset of financial data values affects at least one of the debt-to income factor, the total spending factor, the debt or debt portfolio factor, the saving factor, the liquid reserves factor, or the payment history factor;
calculate a simulated financial health score using the at least one changed value for at least one of the subset of financial data values; and
provide an indication of the simulated financial health score to the user device.

9. The system of claim 8, wherein the subset of financial values comprises:
a yearly gross income, minimum monthly debt payments, other monthly expenses, liquid reserves, and monthly savings.

10. The system of claim 8, wherein the subset of financial values comprises at least one of:
a yearly gross income, a minimum monthly debt payment, another monthly expense, liquid reserves, and monthly savings.

11. The system of claim 8, wherein the memory stores additional computer-executable instructions that, if executed, cause the one or more processors to:
provide at least two indications of the simulated financial health score corresponding to at least two different values of the at least one changed value for at least one of the subset of financial data values.

12. The system of claim 8, wherein the memory stores additional computer-executable instructions that, if executed, cause the one or more processors to:
determine the past financial health score by determining and combining at least three of the debt-to income factor, the total spending factor, the debt or debt portfolio factor, the saving factor, the liquid reserves factor, or the payment history factor.

13. The system of claim 12, wherein the memory stores additional computer-executable instructions that, if executed, cause the one or more processors to:
obtain a plurality of financial data values directly from one or more financial sources, wherein the plurality of financial data values are used to calculate at least three of the debt-to income factor, the total spending factor, the debt or debt portfolio factor, the saving factor, the liquid reserves factor, or the payment history factor.

14. The system of claim 13, wherein the memory stores additional computer-executable instructions that, if executed, cause the one or more processors to:
classify the plurality of financial data values into one of a plurality of categories, wherein individual categories of the plurality of categories correspond to at least one of the debt-to income factor, the total spending factor, the debt or debt portfolio factor, the saving factor, the liquid reserves factor, or the payment history factor.

15. The system of claim 8, wherein the memory stores additional computer-executable instructions that, if executed, cause the one or more processors to:
provide the values of each of the subset of financial values to the user device.

16. The system of claim 15, wherein the memory stores additional computer-executable instructions that, if executed, cause the one or more processors to:
provide a user interface that includes selectable items to change each of the subset of financial values to the user device, wherein upon receiving a change to at least one of the subsets of financial values, the computer-executable instructions that, if executed, further cause the one or more processors to:
determine a revised financial health score using the change to at least one of the subsets of financial values.

17. The system of claim 8, wherein the memory stores additional computer-executable instructions that, if executed, cause the one or more processors to:
obtain a second request to change at least one value of the subset of financial values to a second value; and
responsive to the obtaining the second request, determine a revised financial health score using the second value.

18. A method for simulating changes to a financial health score, comprising:
obtaining a request from a user device to simulate an impact on a financial health score of an entity caused by a change in at least one of a subset of financial data values used to determine the financial health score;
determining a past financial health score by combining values for at least three of a debt-to income factor, a total spending factor, a debt or debt portfolio factor, a saving factor, a liquid reserves factor, or a payment history factor, wherein the change in at least one of the subset of financial data values affects at least one of the debt-to income factor, the total spending factor, the debt or debt portfolio factor, the saving factor, the liquid reserves factor, or the payment history factor;
calculating a simulated financial health score using the at least one changed value for at least one of the subset of financial data values; and
providing the simulated financial health score and the subset of financial data values to the user device.

19. The method of claim 18, wherein the subset of financial values comprises at least two of:
a yearly gross income, minimum monthly debt payments, other monthly expenses, liquid reserves, and monthly savings.

20. The method of claim 18, further comprising:
providing a range of simulated financial health scores corresponding to a range of different values for the at least one of the subsets of financial data values.

21. The method of claim 18, further comprising:
obtaining a plurality of financial data values directly from one or more financial sources, wherein the plurality of financial data values are used to calculate at least three of the debt-to income factor, the total spending factor, the debt or debt portfolio factor, the saving factor, the liquid reserves factor, or the payment history factor.

22. The method of claim 18, further comprising:
providing options to change each of the subset of financial values to the user device, wherein upon receiving a change to at least one of the subsets of financial values, the method further comprises:
determining a revised financial health score using the change to at least one of the subsets of financial values.
